(19) United States
(12) Patent Application Publication
(10) Pub. No.: US 2026/0019520 A1
(43) Pub. Date: Jan. 15, 2026

(54) INFORMATION PROCESSING APPARATUS, INFORMATION PROCESSING METHOD, AND COMPUTER-READABLE, NON-TRANSITORY MEDIUM

(71) Applicant: PFU LIMITED, Kahoku-shi (JP)

(72) Inventors: Masaaki Sakai, Kahoku-shi (JP); Katsunori Aoyama, Kahoku-shi (JP); Tomoaki Wada, Kahoku-shi (JP)

(21) Appl. No.: 19/257,919

(22) Filed: Jul. 2, 2025

(30) Foreign Application Priority Data
Jul. 12, 2024 (JP) 2024-112556
Dec. 4, 2024 (JP) 2024-211816

(51) Int. Cl. H04N 1/00

(52) U.S. Cl. CPC H04N 1/00933; H04N 1/00018; H04N 1/00034; H04N 1/00076; H04N 1/00087

(57) ABSTRACT

An information processing apparatus includes: a measurement circuit to measure time; and a control circuit to determine whether the measured time is accurate and execute a predetermined operation of correcting a time drift based on a determination that the measured time is inaccurate.

### CROSS-REFERENCE TO RELATED APPLICATIONS

This patent application is based on and claims priority pursuant to 35 U.S.C. § 119 (a) to Japanese Patent Application Nos. 2024-112556, filed on Jul. 12, 2024, and 2024-211816, filed on Dec. 4, 2024, in the Japan Patent Office, the entire disclosure of which is hereby incorporated by reference herein.

### BACKGROUND

The present disclosure relates to an information processing apparatus, an information processing method, and a computer-readable, non-transitory medium.

An information terminal is disclosed that determines, when data and a program having a predetermined expiration date are to be executed, whether a time measured by a time measurement unit, a Global Positioning System (GPS) time, and a sharing time acquired from a server are within the expiration date. When all the times are within the expiration date, the information terminal permits the execution of the data and the program having the predetermined expiration date.

A time data receiving apparatus is disclosed that receives a radio wave including time data, corrects current time information based on the time data included in the received radio wave, and calculates an error occurring after the previous time correction. The time data receiving apparatus clearly indicates a possibly incorrect digit by special control according to the calculated error. Further, the time data receiving apparatus calculates an error based on the monthly accuracy and the elapsed time from the previous time correction to the current time. Further, the time data receiving apparatus calculates an error based on the elapsed time from the penultimate time correction to the previous time correction, the amount of previous time correction, and the elapsed time from the previous time correction to the current time.

### SUMMARY

The information processing apparatus according to one aspect of the present disclosure includes a measurement circuit and a control circuit. The measurement circuit measures time. The control circuit determines whether the measured time is accurate and executes a predetermined operation of correcting a time drift based on a determination that the measured time is inaccurate.

The information processing method according to another aspect of the present disclosure includes measuring time; determining whether the measured time is accurate; and executing a predetermined operation of correcting a time drift based on a determination that the measured time is inaccurate.

The computer-readable, non-transitory medium according to still another aspect of the present disclosure includes a computer-readable, non-transitory medium storing a computer program, which causes an information processing apparatus to execute a process, the process including measuring time; determining whether the measured time is accurate; and executing a predetermined operation of correcting a time drift based on a determination that the measured time is inaccurate.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an information processing apparatus according to an embodiment of the present disclosure;

FIG. 2 is a diagram illustrating a conveyance path in the information processing apparatus according to the embodiment of the present disclosure;

FIG. 3 is a block diagram schematically illustrating a configuration of the information processing apparatus according to the embodiment of the present disclosure;

FIG. 4 is a schematic diagram illustrating an example of a power supply mechanism;

FIG. 5 is a diagram schematically illustrating an example configuration of a second storage device and a second processing circuit;

FIG. 6 is a flowchart illustrating an example of the operations of a monitoring process;

FIG. 7 is a flowchart of an example of the operations of a media reading process;

FIG. 8 is a flowchart illustrating an example of the operations of a time setting process;

FIG. 9 is a flowchart illustrating an example of the operations of a time setting process according to a second embodiment of the present disclosure;

FIG. 10 is a flowchart illustrating an example of the operations of a media reading process according to the second embodiment of the present disclosure;

FIG. 11 is a flowchart illustrating an example of the operations of a transmission/reception process according to the second embodiment of the present disclosure;

FIG. 12 is a flowchart illustrating an example of the operations of a detection process according to the second embodiment of the present disclosure;

FIG. 13 is a flowchart illustrating an example of the operations of the detection process according to the second embodiment of the present disclosure;

FIG. 14A illustrates an example of a first notification screen;

FIG. 14B illustrates an example of a second notification screen;

FIG. 14C illustrates an example of a third notification screen;

FIG. 15 is a flowchart illustrating an example of the operations of a setting process according to the second embodiment of the present disclosure; and

FIG. 16 is a block diagram schematically illustrating another example configuration of the second processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing method, and a control program according to embodiments of the present disclosure will be described hereinafter with reference to the drawings. The technical scope of the present disclosure is not limited to the embodiments described below and covers the invention defined in the appended claims and its equivalents.

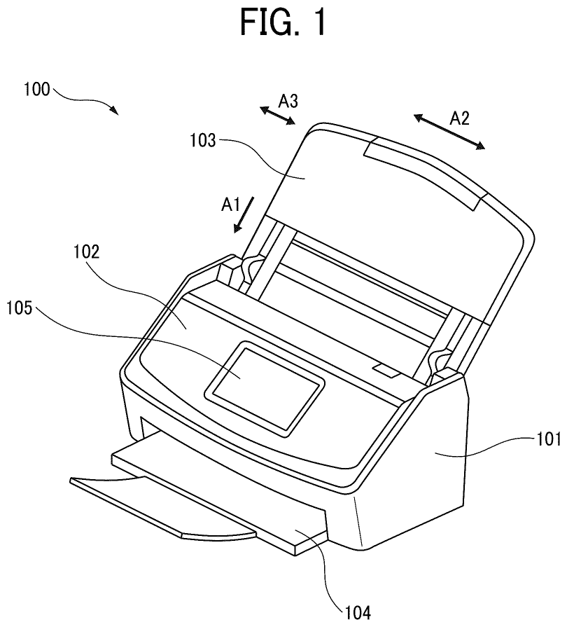

FIG. 1 is a perspective view of an information processing apparatus 100. In an example, the information processing apparatus 100 is configured as an image scanner.

The information processing apparatus 100 is a media conveying apparatus or an image reading apparatus that conveys media such as documents, captures images of the media, and ejects the media. Examples of the media include paper, thick paper, cards, booklets, and passports. The information processing apparatus 100 may be a facsimile machine, a copier, a printer multifunction peripheral (MFP), or the like. The information processing apparatus 100 may be a flatbed apparatus that captures images of media without conveying the media. The information processing apparatus 100 may be any apparatus such as a server, a personal computer (PC), a smartphone, a mobile phone, or a printer.

In FIG. 1, arrow A1 indicates the direction in which the media are conveyed (also “media conveying direction A1”), arrow A2 indicates the width direction perpendicular to the media conveying direction A1, and arrow A3 indicates the height direction perpendicular to a media conveying path. In the following, upstream is toward the source in the media conveying direction A1, and downstream is away from the source in the media conveying direction A1. The width direction A2 is an example of a direction intersecting the media conveying direction A1.

The information processing apparatus 100 includes, for example, a lower housing 101, an upper housing 102, a media tray 103, an ejection tray 104, and a display operation device 105.

The upper housing 102 is positioned to cover the upper face of the information processing apparatus 100 and is engaged with the lower housing 101 via a hinge such that the upper housing 102 can be opened and closed to, for example, remove a jammed medium or clean the inside of the information processing apparatus 100.

The media tray 103 is engaged with the lower housing 101 and is rotatable around a hinge. The media tray 103 is positioned to cover the lower housing 101 and the upper housing 102 when the information processing apparatus 100 is not in use, and functions as an outer cover. On the other hand, when the information processing apparatus 100 is in use, the media tray 103 is positioned such that a medium can be placed on the media tray 103 to hold the medium to be fed and conveyed. The ejection tray 104 is engaged with the lower housing 101 and holds the medium that has been ejected. The ejection tray 104 may be engaged with the upper housing 102 via a hinge or the like.

The display operation device 105 includes a display such as a liquid crystal display or an organic electroluminescent (EL) display, and an interface circuit that outputs image data to the display, and displays the image data on the display. The display operation device 105 further includes a touch panel input device and an interface circuit that acquires a signal from the input device, receives an operation performed by a user, and outputs a signal corresponding to the input from the user. The display and the operation device may be separate from each other.

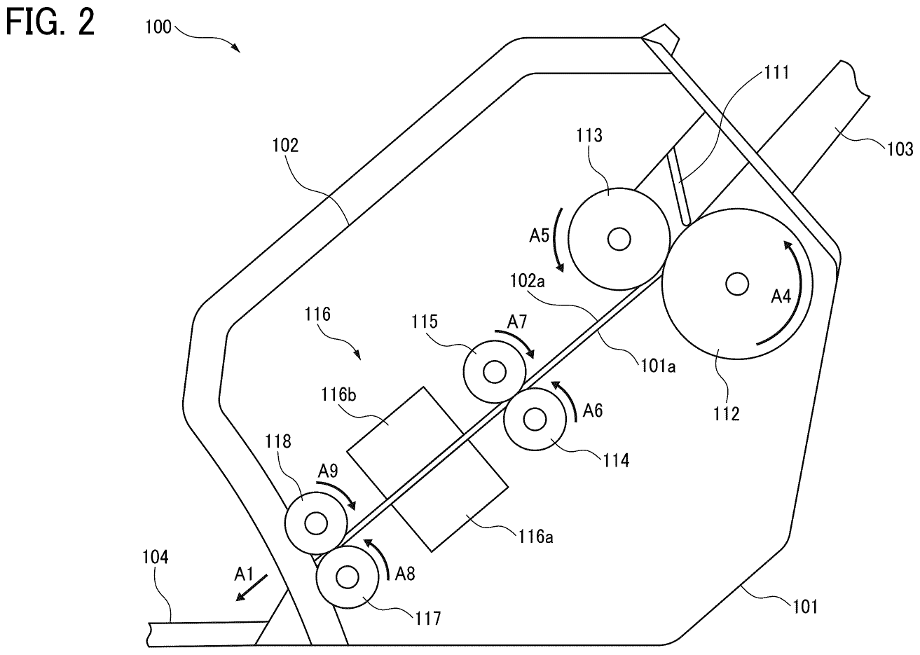

FIG. 2 is a diagram illustrating a conveyance path in the information processing apparatus 100.

The conveyance path in the information processing apparatus 100 includes, for example, a media sensor 111, a feed roller 112, a separation roller 113, a first conveyance roller 114, a second conveyance roller 115, an imaging device 116, a first ejection roller 117, and a second ejection roller 118.

The conveyance path may include two or more feed rollers 112, two or more separation rollers 113, two or more first conveyance rollers 114, two or more second conveyance rollers 115, two or more first ejection rollers 117, and/or two or more second ejection rollers 118. In this case, the two or more feed rollers 112, the two or more separation rollers 113, the two or more first conveyance rollers 114, the two or more second conveyance rollers 115, the two or more first ejection rollers 117, and/or the two or more second ejection rollers 118 are arranged side by side and spaced apart in the width direction A2.

The upper face of the lower housing 101 defines a lower guide 101a for the media conveying path. The lower face of the upper housing 102 defines an upper guide 102a for the media conveying path. As illustrated in FIG. 2, the media conveying path is a so-called straight path, and the vertical relative positions of the front and back sides of a medium remain unchanged from the state in which the medium is placed on the media tray 103 before being conveyed to the state in which the medium is placed on the ejection tray 104 after being ejected. Since the media conveying path is a straight path, the information processing apparatus 100 is compact.

The media sensor 111 is located upstream of the feed roller 112 and the separation roller 113. The media sensor 111 includes a contact detection sensor and detects whether a medium is placed on the media tray 103. The media sensor 111 generates and outputs a media signal whose signal value changes depending on whether a medium is placed on the media tray 103. The media sensor 111 is not limited to a contact detection sensor, and may be any other sensor such as an optical detection sensor that can detect the presence of a medium.

The feed roller 112 is located in the lower housing 101 and sequentially separates and feeds the media placed on the media tray 103 one by one, starting from the bottom. The separation roller 113 is a so-called brake roller or retard roller. The separation roller 113 is located in the upper housing 102 and faces the feed roller 112 to separate the media placed on the media tray 103 one by one. The separation roller 113 is rotatable in a direction A5 opposite to the rotation direction for conveying the media (may be hereinafter referred to as a media feeding direction). Alternatively, the separation roller 113 is stoppable. Instead of the separation roller 113, a separation pad may be used.

The first conveyance roller 114 and the second conveyance roller 115 are located downstream of the feed roller 112 and the separation roller 113 in the media conveying direction A1, and face each other. The first conveyance roller 114 and the second conveyance roller 115 convey the media fed by the feed roller 112 and the separation roller 113 to the imaging device 116.

The imaging device 116 captures images of the media conveyed by the first conveyance roller 114 and the second conveyance roller 115. The imaging device 116 includes a first imaging device 116a and a second imaging device 116b facing each other with the media conveying path therebetween.

The first imaging device 116a includes an imaging sensor that is a unity-magnification contact image sensor (CIS) including complementary metal oxide semiconductor (CMOS) imaging elements aligned linearly in a main scanning direction. The first imaging device 116a further includes a lens that forms an image on the imaging elements, and an analog-to-digital (A/D) converter. The A/D converter amplifies electrical signals output from the imaging elements and performs analog-to-digital (A/D) conversion. The first imaging device 116a captures images of the front side of the media being conveyed to generate input images sequentially, and outputs the input images.

Similarly, the second imaging device 116b includes an imaging sensor that is a unity-magnification CIS including CMOS imaging elements aligned linearly in the main scanning direction. The second imaging device 116b further includes a lens that forms an image on the imaging elements, and an A/D converter. The A/D converter amplifies electrical signals output from the imaging elements and performs A/D conversion. The second imaging device 116b captures images of the back side of the media being conveyed to generate line images sequentially, and outputs the line images.

The information processing apparatus 100 may include either the first imaging device 116a or the second imaging device 116b to read only one side of the media. In one example, the imaging sensor may be a line sensor that employs a unity-magnification CIS including charge-coupled device (CCD) imaging elements. In another example, the imaging sensor may be a reduction-magnification line sensor including CMOS or CCD imaging elements.

The first ejection roller 117 and the second ejection roller 118 are located downstream of the imaging device 116 in the media conveying direction A1, and face each other. The first ejection roller 117 and the second ejection roller 118 eject the media that are conveyed by the first conveyance roller 114 and the second conveyance roller 115 and are processed (or imaged) by the imaging device 116 to the ejection tray 104.

A medium placed on the media tray 103 is conveyed between the lower guide 101a and the upper guide 102a in the media conveying direction A1 as the feed roller 112 rotates in a direction indicated by arrow A4 in FIG. 2, that is, in the media feeding direction. When two or more media are placed on the media tray 103, a medium in contact with the feed roller 112 is separated from the rest of the media on the media tray 103 due to the action of the feed roller 112 and the separation roller 113. This operation limits the feeding of the media other than the separated medium (prevention of multifeed).

The medium is fed between the first conveyance roller 114 and the second conveyance roller 115 while being guided by the lower guide 101a and the upper guide 102a. The medium is fed between the first imaging device 116a and the second imaging device 116b as the first conveyance roller 114 and the second conveyance roller 115 rotate in directions indicated by arrows A6 and A7 in FIG. 2, respectively. The medium read by the imaging device 116 is ejected onto the ejection tray 104 as the first ejection roller 117 and the second ejection roller 118 rotate in directions indicated by arrows A8 and A9 in FIG. 2, respectively.

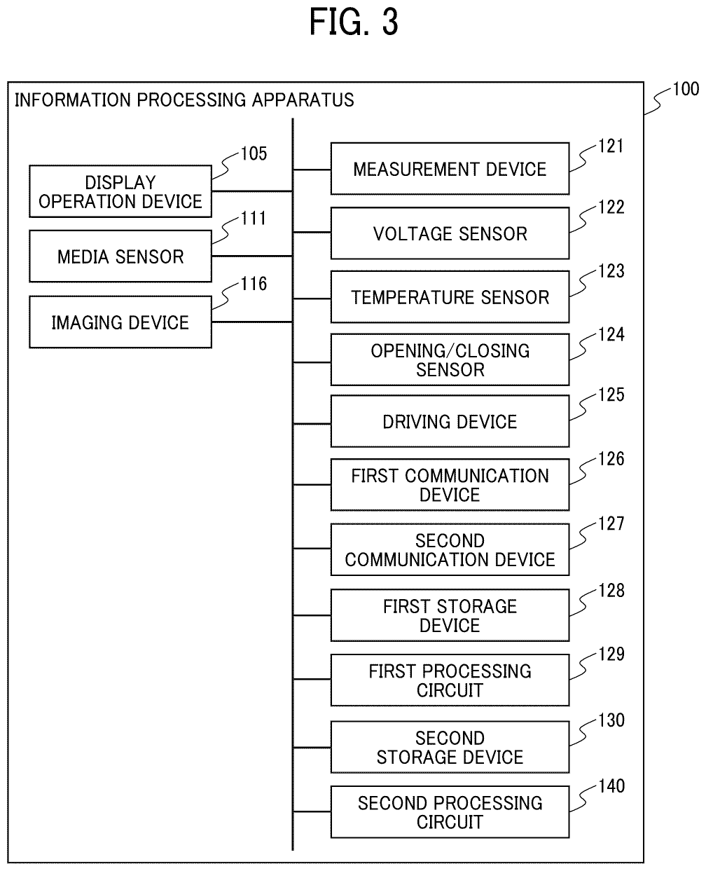

FIG. 3 is a block diagram schematically illustrating a configuration of the information processing apparatus 100.

The information processing apparatus 100 includes, in addition to the components described above, for example, a measurement device 121, a voltage sensor 122, a temperature sensor 123, an opening/closing sensor 124, a driving device 125, a first communication device 126, a second communication device 127, a first storage device 128, a first processing circuit 129, a second storage device 130, and a second processing circuit 140.

The measurement device 121 is an example of a measurement unit and measures time. The measurement device 121 is, for example, a real-time clock (RTC). The measurement device 121 includes a capacitor or the like. The measurement device 121 receives the time setting from the second processing circuit 140 and stores the time setting in the capacitor or the like. The measurement device 121 further includes a crystal oscillator and an oscillation circuit, and the oscillation circuit converts the oscillation of the crystal oscillator into a clock signal. The measurement device 121 calculates the current time based on the number of oscillations of the clock signal from when the time setting is received, and outputs a time signal indicating the calculated current time to the second processing circuit 140.

The voltage sensor 122 is a voltmeter that detects a voltage applied to the measurement device 121, and outputs a voltage signal indicating the voltage applied to the measurement device 121 to the second processing circuit 140.

The temperature sensor 123 detects an ambient temperature of the information processing apparatus 100, and outputs a temperature signal indicating the detected ambient temperature to the second processing circuit 140. The ambient temperature includes the temperature (air temperature) outside the information processing apparatus 100 or the temperature inside the information processing apparatus 100. In particular, the ambient temperature includes the temperature around the measurement device 121.

The opening/closing sensor 124 is a contact detection sensor that detects the open or closed state of the media tray 103. The opening/closing sensor 124 detects whether the media tray 103 is open or closed with respect to the lower housing 101 or the upper housing 102 by, for example, detecting whether a protrusion provided on the media tray 103 is engaged with a recess provided in the lower housing 101 or the upper housing 102. The opening/closing sensor 124 outputs an opening/closing signal indicating whether the media tray 103 is open or closed to the second processing circuit 140.

The driving device 125 includes one or more motors. The driving device 125 generates a driving force for rotating the feed roller 112, the separation roller 113, the first conveyance roller 114, the second conveyance roller 115, the first ejection roller 117, and/or the second ejection roller 118 in response to a control signal from the second processing circuit 140. The driving device 125 is, for example, a direct current (DC) motor. The driving device 125 may be a motor other than a DC motor, such as a stepping motor. One of the first conveyance roller 114 and the second conveyance roller 115 may be a driven roller that is driven by the other of the first conveyance roller 114 and the second conveyance roller 115. One of the first ejection roller 117 and the second ejection roller 118 may be a driven roller that is driven by the other of the first ejection roller 117 and the second ejection roller 118.

The first communication device 126 is an example of a communication unit that communicates with an external device. The first communication device 126 includes an antenna that transmits and receives wireless signals, and a wireless communication interface circuit for transmitting and receiving signals through a wireless communication line according to a predetermined communication protocol. The predetermined communication protocol is, for example, a wireless local area network (LAN) protocol. The first communication device 126 establishes a communication connection with an external device such as another communication device (e.g., a PC or a mobile information terminal) directly or via a network such as a wireless LAN to transmit and receive an input image and various types of information.

The first communication device 126 may include a wired communication interface circuit for transmitting and receiving signals through a wired communication line according to a communication protocol such as a wired LAN protocol. The first communication device 126 may include a wireless communication interface circuit for transmitting and receiving signals through a mobile phone line according to a mobile phone communication protocol such as third generation (3G), fourth generation (4G), or fifth generation (5G). The first communication device 126 may include a wired communication interface circuit for transmitting and receiving signals through a telephone line according to a facsimile communication protocol such as the Group 4 (G4) standard. The first communication device 126 may be a global navigation satellite system (GNSS) signal receiver or a navigation satellite system (NSS) signal receiver. The first communication device 126 may be a standard time radio wave receiver.

Further, the first communication device 126 detects whether a communication cable is inserted into a communication connector, and outputs a first insertion signal indicating whether the communication cable is inserted into the communication connector to the second processing circuit 140. The first communication device 126 further detects whether communication through the first communication device 126 is possible, and outputs a first state signal indicating whether communication through the first communication device 126 is possible to the second processing circuit 140. For example, in a case where the first communication device 126 has established a link with a network device, it is determined that communication through the first communication device 126 is possible. In a case where the first communication device 126 has not established a link with a network device, it is determined that communication through the first communication device 126 is not possible.

The second communication device 127 is an example of a communication unit that communicates with an external device. The second communication device 127 includes an interface circuit compliant with, for example, a serial bus, such as Universal Serial Bus (USB), and establishes a direct communication connection with another communication device or an external storage device such as a USB memory to transmit and receive an input image and various types of information. The second communication device 127 may include an interface circuit compliant with a short-range wireless communication standard such as Bluetooth®, near-field communication (NFC), or TransferJet. The second communication device 127 may include an interface circuit compliant with an interface standard such as Serial Peripheral Interface (SPI) or Secure Digital Input/Output (SDIO). In this case, the second communication device 127 may establish a direct communication connection with an external storage device such as a multimedia card or a Secure Digital (SD) memory card to transmit and receive an input image and various types of information.

Further, the second communication device 127 detects whether a communication cable is inserted into a communication connector, and outputs a second insertion signal indicating whether the communication cable is inserted into the communication connector to the second processing circuit 140. The second communication device 127 further detects whether communication through the second communication device 127 is possible, and outputs a second state signal indicating whether communication through the second communication device 127 is possible to the second processing circuit 140. For example, in a case where the second communication device 127 has established a link with another communication device, it is determined that communication through the second communication device 127 is possible. In a case where the second communication device 127 has not established a link with another communication device, it is determined that communication through the second communication device 127 is not possible.

The first storage device 128 includes, for example, memory devices such as a random-access memory (RAM) and a read-only memory (ROM), a fixed disk device such as a hard disk, or a portable storage device such as a flexible disk or an optical disk. The first storage device 128 stores, for example, computer programs, databases, and tables used in various processes for the information processing apparatus 100. The computer programs may be installed in the first storage device 128 from a computer-readable portable recording medium by using a known setup program or the like. Examples of the portable recording medium include a compact disc read-only memory (CD-ROM) and a digital versatile disc read-only memory (DVD-ROM). Alternatively, the computer programs may be distributed from a server or the like and installed in the first storage device 128.

The first processing circuit 129 operates according to a program stored in advance in the first storage device 128. The first processing circuit 129 is, for example, a central processing unit (CPU). The first processing circuit 129 may be, for example, a digital signal processor (DSP), a large-scale integration (LSI) circuit, an application-specific integrated circuit (ASIC), or a field-programmable gate array (FPGA).

The first processing circuit 129 is connected to and controls the display operation device 105, the media sensor 111, the imaging device 116, the measurement device 121, the voltage sensor 122, the temperature sensor 123, the opening/closing sensor 124, the driving device 125, the first communication device 126, the second communication device 127, the first storage device 128, and the like. The first processing circuit 129 controls power supply to the information processing apparatus 100.

The second storage device 130 includes, for example, memory devices such as a RAM and a ROM, a fixed disk device such as a hard disk, or a portable storage device such as a flexible disk or an optical disk. The second storage device 130 stores, for example, computer programs, databases, and tables used in various processes for the information processing apparatus 100. The computer programs may be installed in the second storage device 130 from a computer-readable portable recording medium by using a known setup program or the like. Examples of the portable recording medium include a CD-ROM and a DVD-ROM. Alternatively, the computer programs may be distributed from a server or the like and installed in the second storage device 130.

The second processing circuit 140 operates according to a program stored in advance in the second storage device 130. The second processing circuit 140 is, for example, a CPU. The second processing circuit 140 may be, for example, a DSP, an LSI circuit, an ASIC, or an FPGA.

The second processing circuit 140 is connected to and controls the display operation device 105, the media sensor 111, the imaging device 116, the measurement device 121, the voltage sensor 122, the temperature sensor 123, the opening/closing sensor 124, the driving device 125, the first communication device 126, the second communication device 127, the second storage device 130, and the like. The second processing circuit 140 performs drive control of the driving device 125, imaging control of the imaging device 116, and the like, based on a media signal acquired from the media sensor 111. Further, the second processing circuit 140 manages the time in the measurement device 121.

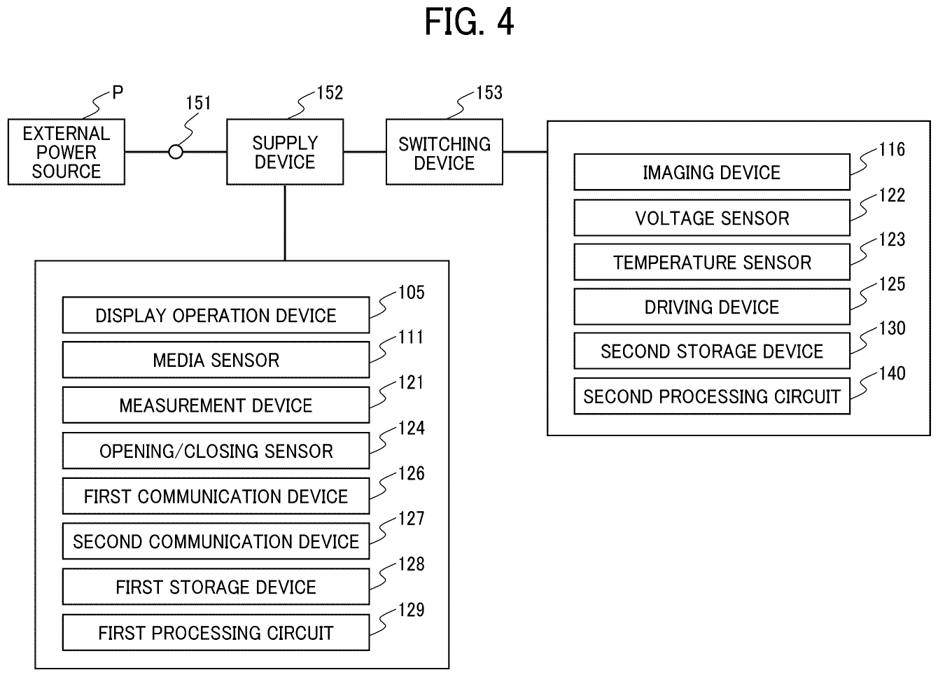

FIG. 4 is a schematic diagram illustrating a power supply mechanism of the information processing apparatus 100.

As illustrated in FIG. 4, the information processing apparatus 100 further includes an input terminal 151, a supply device 152, and a switching device 153.

Power supplied from an external power source P is input to the input terminal 151. The information processing apparatus 100 operates only with the power input from the external power source P to the input terminal 151. In other words, the information processing apparatus 100 does not include a power storage device that can supply power to the measurement device 121. The power storage device includes a primary battery such as a lithium battery, an alkaline battery, or a manganese battery, or a secondary battery such as a lithium ion battery, a nickel-metal hydride battery, or a nickel-cadmium battery. The power storage device includes a capacitor such as an electric double layer capacitor, an electrolytic capacitor, a ceramic capacitor, or a film capacitor. In particular, the capacitor includes a capacitor with 3000 μF or less. The power storage device includes a power generation element that executes photovoltaic power generation by using a photovoltaic (PV) cell (solar cell), such as a silicon cell, a compound semiconductor cell, a perovskite cell, or a dye-sensitized cell, or the like, thermal power generation by using a thermoelectric element (Seebeck element) or the like, or vibration power generation by using a piezoelectric element, an electromagnetic induction element, an inverse magnetostrictive effect element, or the like.

Since the information processing apparatus 100 does not include a power storage device that can supply power to the measurement device 121, the increase in the cost and size of the information processing apparatus 100 can be reduced, and the increase in the time and effort for maintenance of the information processing apparatus 100 due to degradation or failure of the power storage device can be eliminated.

The supply device 152 is an example of a supply unit. The supply device 152 is located between the input terminal 151 and the switching device 153. The supply device 152 supplies the power input to the input terminal 151 to the imaging device 116, the voltage sensor 122, the temperature sensor 123, the driving device 125, the second storage device 130, and the second processing circuits 140 through the switching device 153. The supply device 152 also supplies the power input to the input terminal 151 directly to the display operation device 105, the media sensor 111, the measurement device 121, the opening/closing sensor 124, the first communication device 126, the second communication device 127, the first storage device 128, and the first processing circuit 129 without routing the power through the switching device 153.

The supply device 152 may supply the power input to the input terminal 151 to devices other than the measurement device 121, the first storage device 128, and the first processing circuit 129 through the switching device 153. The supply device 152 may supply the power input to the input terminal 151 directly to all the devices without routing the power through the switching device 153. The supply device 152 may supply the power input to the input terminal 151 to all the devices through the switching device 153.

The switching device 153 switches between supplying and not supplying the power input to the input terminal 151 and supplied from the supply device 152 to the imaging device 116, the voltage sensor 122, the temperature sensor 123, the driving device 125, the second storage device 130, and the second processing circuit 140. The switching device 153 switches between supplying and not supplying power under the control of the first processing circuit 129. The switching device 153 is, for example, a semiconductor switch. The switching device 153 may be a mechanical switch.

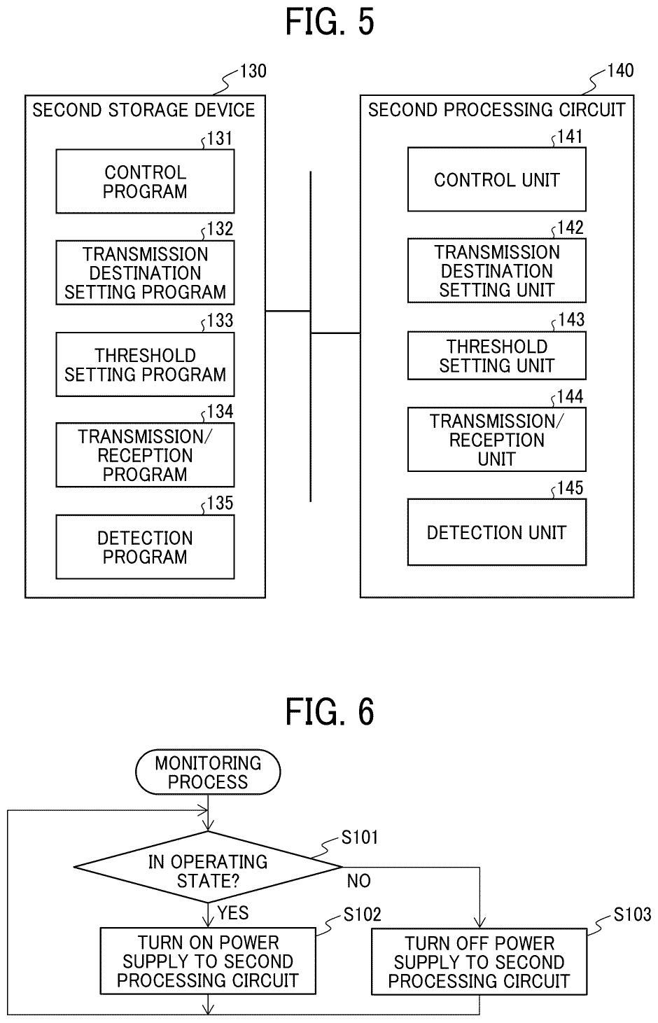

FIG. 5 is a diagram schematically illustrating a configuration of the second storage device 130 and the second processing circuit 140.

As illustrated in FIG. 5, the second storage device 130 stores, for example, a control program 131, a transmission destination setting program 132, a threshold setting program 133, a transmission/reception program 134, and a detection program 135. These programs are functional modules implemented by software that operates on the processor. The second processing circuit 140 reads the programs stored in the second storage device 130 and operates according to the read programs. Thus, the second processing circuit 140 functions as a control unit 141, a transmission destination setting unit 142, a threshold setting unit 143, a transmission/reception unit 144, and a detection unit 145.

FIG. 6 is a flowchart illustrating an example of the operations of a monitoring process performed by the information processing apparatus 100.

An example of the operations of a monitoring process performed by the information processing apparatus 100 will be described hereinafter with reference to the flowchart illustrated in FIG. 6. The flow of the operations described below is executed by, for example, the first processing circuit 129 in cooperation with the components of the information processing apparatus 100 according to the program stored in the first storage device 128 in advance.

First, the first processing circuit 129 determines whether the information processing apparatus 100 is in an operating state (step S101).

The operating state is, for example, a state in which the media tray 103 (i.e., the cover) is open. The control unit 141 receives an opening/closing signal from the opening/closing sensor 124 and determines, based on the received opening/closing signal, whether the media tray 103 is open or closed.

The operating state may be a state in which a medium is placed on the media tray 103. The first processing circuit 129 receives a media signal from the media sensor 111 and determines, based on the received media signal, whether a medium is placed on the media tray 103.

The operating state may be a state in which the communication cable is inserted into the communication connector of the first communication device 126 or the second communication device 127. The first processing circuit 129 receives a first insertion signal from the first communication device 126 and determines, based on the received first insertion signal, whether the communication cable is inserted into the communication connector of the first communication device 126. The first processing circuit 129 receives a second insertion signal from the second communication device 127 and determines, based on the received second insertion signal, whether the communication cable is inserted into the communication connector of the second communication device 127.

The operating state may be a state in which a power switch of the information processing apparatus 100 is on. The first processing circuit 129 determines whether the power switch is on. The first processing circuit 129 may determine whether the power switch is turned on in response to an input operation being performed on the display operation device 105 while the power switch is off. The first processing circuit 129 may determine that the power switch is turned off in a case where no input operation is performed on the display operation device 105 for a predetermined time or longer when the power switch is on.

When the information processing apparatus 100 is in the operating state, the first processing circuit 129 controls the switching device 153 to supply power to the imaging device 116, the voltage sensor 122, the temperature sensor 123, the driving device 125, the second storage device 130, and the second processing circuit 140 (step S102). When power is already supplied to the imaging device 116, the voltage sensor 122, the temperature sensor 123, the driving device 125, the second storage device 130, and the second processing circuit 140, the processing of step S102 may be omitted. Then, the first processing circuit 129 returns the process to step S101 and repeats the processing of steps S101 to S103.

On the other hand, when the information processing apparatus 100 is not in the operating state, the first processing circuit 129 controls the switching device 153 such that power is not supplied to the imaging device 116, the voltage sensor 122, the temperature sensor 123, the driving device 125, the second storage device 130, and the second processing circuit 140 (step S103). When power is already not supplied to the imaging device 116, the voltage sensor 122, the temperature sensor 123, the driving device 125, the second storage device 130, and the second processing circuit 140, the processing of step S103 may be omitted. Then, the first processing circuit 129 returns the process to step S101 and repeats the processing of steps S101 to S103.

As described above, when the information processing apparatus 100 is not in the operating state, the information processing apparatus 100 turns off the supply of power to the devices used to execute the main processing of the information processing apparatus 100. Thus, the increase in power consumption can be reduced. On the other hand, even when the information processing apparatus 100 is not in the operating state, the information processing apparatus 100 continues the supply of power to the measurement device 121. This configuration allows the measurement device 121 to continue to store the current time in the capacitor or the like and continue to detect the number of oscillations of the clock signal to continue to measure the current time.

The monitoring process may be omitted.

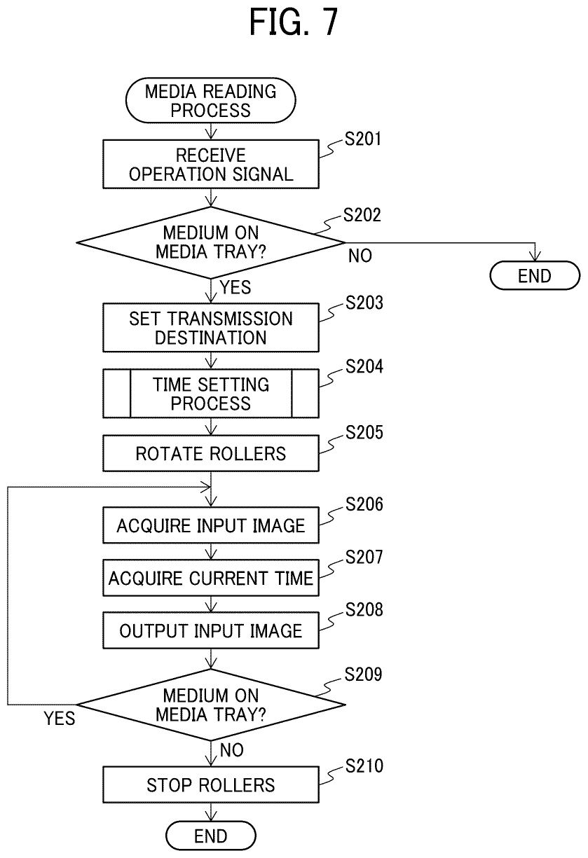

FIG. 7 is a flowchart of an example of the operations of a media reading process performed by the information processing apparatus 100.

An example of the operations of a media reading process performed by the information processing apparatus 100 will be described hereinafter with reference to the flowchart illustrated in FIG. 7. The flow of the operations described below is executed by, for example, the second processing circuit 140 in cooperation with the components of the information processing apparatus 100 according to the programs stored in the second storage device 130 in advance.

First, the control unit 141 waits until a media reading instruction is input by the user using the display operation device 105 or another communication device and an operation signal indicating the media reading instruction is received from the display operation device 105, the first communication device 126, or the second communication device 127 (step S201). The operation signal includes the media reading instruction and a transmission destination of the input image. The transmission destination is designated by the user using the display operation device 105 or another communication device. The transmission destination of the input image is an example of a transmission destination to which information is to be transmitted through the first communication device 126 or the second communication device 127. As the transmission destination of the input image, the address (e.g., an Internet protocol (IP) address or a telephone number) of the transmission destination, a communication device (e.g., the first communication device 126 or the second communication device 127) that transmits and receives information to and from the transmission destination, and the device type (e.g., external communication device or external storage device) of the transmission destination are set. In one example, the transmission destination of the input image is not included in the operation signal and may be set before the media reading process is executed.

Then, the control unit 141 acquires a media signal from the media sensor 111 and determines, based on the acquired media signal, whether a medium is placed on the media tray 103 (step S202). When no medium is placed on the media tray 103, the control unit 141 ends the series of steps.

On the other hand, when a medium is placed on the media tray 103, the transmission destination setting unit 142 stores the transmission destination of the input image in the second storage device 130 and sets the transmission destination (step S203).

Then, the control unit 141 executes a time setting process (step S204). In the time setting process, the control unit 141 determines whether the time measured by the measurement device 121 is accurate. when the time is inaccurate, the control unit 141 sets the time in the measurement device 121 again. The time setting process will be described in detail below.

Then, the control unit 141 controls the driving device 125 to rotate the rollers to convey the medium (step S205). The control unit 141 controls the driving device 125 to rotate the feed roller 112, the separation roller 113, the first conveyance roller 114, the second conveyance roller 115, the first ejection roller 117, and/or the second ejection roller 118. Then, the control unit 141 causes the imaging device 116 to capture an image of the medium, and acquires an input image from the imaging device 116 (step S206).

Then, the control unit 141 receives a time signal from the measurement device 121, and acquires the current time indicated by the received time signal (step S207).

Then, the control unit 141 transmits the acquired input image and current time to the transmission destination set by the transmission destination setting unit 142 in step S203 through the first communication device 126 or the second communication device 127 to output the input image and the current time (step S208). When the transmission destination is a device connectable for communication via a network, in particular, a wireless LAN or a wired LAN, the control unit 141 authenticates communication using the current time and transmits the input image to the transmission destination. When the transmission destination is a device connectable for communication via facsimile, the control unit 141 transmits the current time to the transmission destination as additional information of the input image to be transmitted, together with the input image. When the transmission destination is an external storage device, the control unit 141 transmits the current time to the transmission destination as additional information of the input image to be transmitted, together with the input image. The device set as the transmission destination stores and manages the received input image together with the current time.

Then, the control unit 141 determines whether a medium remains on the media tray 103, based on the media signal received from the media sensor 111 (step S209). when a medium remains on the media tray 103, the control unit 141 returns the process to step S206 and repeats the processing of steps S206 to S209.

On the other hand, when no medium remains on the media tray 103, the control unit 141 controls the driving device 125 to stop the rollers (step S210), and then ends the series of steps. The control unit 141 controls the driving device 125 to stop the feed roller 112, the separation roller 113, the first conveyance roller 114, the second conveyance roller 115, the first ejection roller 117, and/or the second ejection roller 118.

The processing of step S204 may be executed at any time, such as immediately before step S207 or at the time of activation of the information processing apparatus 100. The processing of step S204 may be omitted.

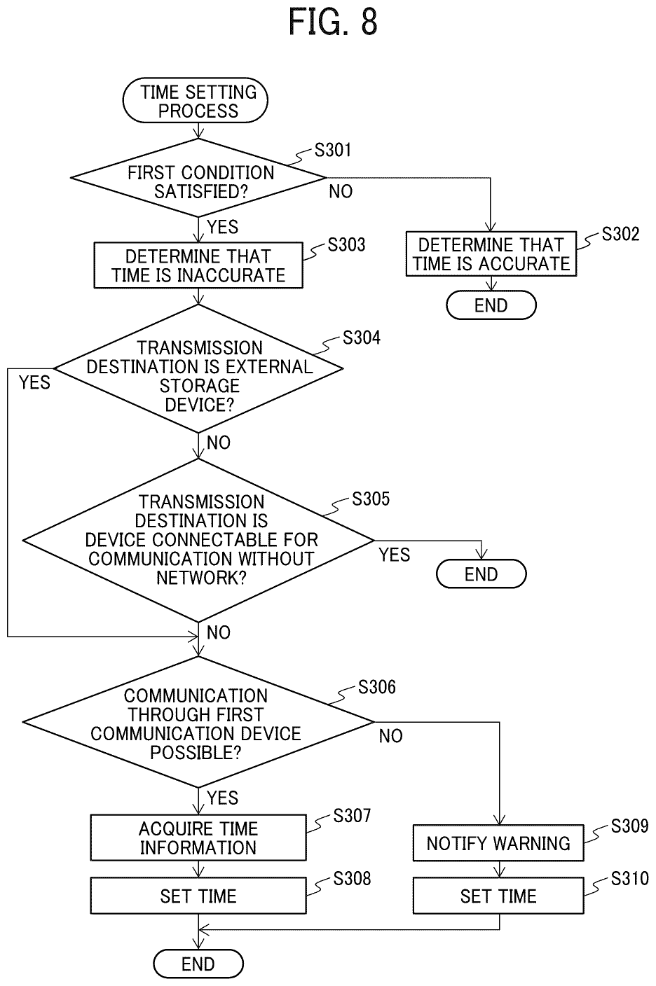

FIG. 8 is a flowchart illustrating an example of the operations of the time setting process.

The time setting process is executed in step S204 in FIG. 7. First, the control unit 141 determines whether a first condition in which there is a possibility that the time measured by the measurement device 121 drifts is satisfied (step S301).

For example, the control unit 141 determines whether the first condition is satisfied, based on the voltage supplied to the measurement device 121. The control unit 141 receives a voltage signal from the voltage sensor 122, and determines whether the voltage indicated by the received voltage signal is within a predetermined voltage range to determine whether the measurement device 121 is operating normally. The predetermined voltage range is set in advance to a range of voltages at which the measurement device 121 can operate normally, in particular, a range greater than or equal to a minimum voltage at which the measurement device 121 can operate normally. when the measurement device 121 is not operating normally, the control unit 141 determines that the first condition is satisfied. when the measurement device 121 is operating normally, the control unit 141 determines that the first condition is not satisfied. Accordingly, the control unit 141 can easily and accurately determine whether the first condition is satisfied.

The control unit 141 may determine whether the first condition is satisfied, based on the history of voltages supplied to the measurement device 121 from the previous time the time was set in the measurement device 121 to the current time. In this case, the control unit 141 periodically receives voltage signals from the voltage sensor 122, and stores the voltages indicated by the received voltage signals in the second storage device 130 as a history. The control unit 141 determines whether each of the voltages stored as the history is within the predetermined voltage range. When all of the voltages stored as the history are within the predetermined voltage range, the control unit 141 determines that the measurement device 121 is operating normally. when any one of the voltages stored as the history is outside the predetermined voltage range, the control unit 141 determines that the measurement device 121 is not operating normally. Accordingly, the control unit 141 can more accurately determine whether the first condition is satisfied.

The control unit 141 may determine whether the time measured by the measurement device 121 is accurate, based on the ambient temperature of the information processing apparatus 100. The control unit 141 receives a temperature signal from the temperature sensor 123, and determines whether the ambient temperature indicated by the received temperature signal is within a predetermined temperature range to determine whether the measurement device 121 is operating normally. The predetermined temperature range is set in advance to a range of temperatures at which the measurement device 121 is estimated to operate normally, in particular, a range greater than or equal to a minimum temperature at which the measurement device 121 is estimated to operate normally. when the measurement device 121 is not operating normally, the control unit 141 determines that the first condition is satisfied. When the measurement device 121 is operating normally, the control unit 141 determines that the first condition is not satisfied. Accordingly, the control unit 141 can easily and accurately determine whether the first condition is satisfied.

The control unit 141 may determine whether the first condition is satisfied, based on the history of ambient temperatures of the information processing apparatus 100 from the previous time the time was set in the measurement device 121 to the current time. In this case, the control unit 141 periodically receives temperature signals from the temperature sensor 123, and stores the ambient temperatures indicated by the received temperature signals in the second storage device 130 as a history. The control unit 141 determines whether each of the ambient temperatures stored as the history is within the predetermined temperature range. when all of the ambient temperatures stored as the history are within the predetermined temperature range, the control unit 141 determines that the measurement device 121 is operating normally. When any one of the ambient temperatures stored as the history is outside the predetermined temperature range, the control unit 141 determines that the measurement device 121 is not operating normally. Accordingly, the control unit 141 can more accurately determine whether the first condition is satisfied.

The control unit 141 may determine whether the first condition is satisfied, based on the time measured by the measurement device 121. The control unit 141 receives time information from the measurement device 121. When the time indicated by the received time information has not elapsed a predetermined amount of time or more since the time measured by the measurement device 121 in an initial state (a state in which no time is set), the control unit 141 determines that the first condition is satisfied. On the other hand, when the time indicated by the time information has elapsed the predetermined amount of time or more since the time measured by the measurement device 121 in the initial state, the control unit 141 determines that the first condition is not satisfied. The predetermined amount of time is set to a sufficiently long period of time. When the time indicated by the received time information is not within a predetermined period, the control unit 141 may determine that the first condition is satisfied. When the time indicated by the time information is within the predetermined period, the control unit 141 may determine that the first condition is not satisfied. The predetermined period is set in advance to a period from the product release date to the product support end date of the information processing apparatus 100. Accordingly, the control unit 141 can easily and accurately determine whether the first condition is satisfied.

The control unit 141 may determine whether the first condition is satisfied, based on the elapsed time from the previous time the time was set in the measurement device 121. When the elapsed time from the previous time the time was set in the measurement device 121 is greater than or equal to a time threshold set in advance, the control unit 141 determines that the first condition is satisfied. When the elapsed time from the previous time the time was set in the measurement device 121 is less than the time threshold, the control unit 141 determines that the first condition is not satisfied. Accordingly, the control unit 141 can easily and accurately determine whether the first condition is satisfied.

When it is determined that the first condition is not satisfied, the control unit 141 determines that the time measured by the measurement device 121 is accurate (step S302), and then ends the series of steps. On the other hand, when it is determined that the first condition is satisfied, the control unit 141 determines that the time measured by the measurement device 121 is inaccurate (step S303). As described above, the control unit 141 determines whether the time measured by the measurement device 121 is accurate, based on whether the first condition is satisfied. Accordingly, the information processing apparatus 100 can accurately determine whether the time measured by the measurement device 121 is accurate.

Then, the control unit 141 determines whether the transmission destination of the input image is an external storage device (step S304). When the transmission destination of the input image is an external storage device, the control unit 141 causes the process to proceed to step S306. For example, when the transmission destination of the input image is a USB memory, a multimedia card, an SD memory card, or the like, the control unit 141 determines that the transmission destination of the input image is an external storage device.

On the other hand, when the transmission destination of the input image is not an external storage device, the control unit 141 determines whether the transmission destination of the input image is an external device connectable for communication without a network (step S305). For example, when the transmission destination of the input image is a device connectable for communication through the second communication device 127, the control unit 141 determines that the transmission destination of the input image is an external device connectable for communication without a network. That is, when the transmission destination of the input image is a device connectable for communication conforming to a communication standard such as USB, Bluetooth®, NFC, or TransferJet, the control unit 141 determines that the transmission destination of the input image is an external device connectable for communication without a network. The control unit 141 may also determine that the transmission destination of the input image is an external device connectable for communication without a network when the transmission destination of the input image is a device connectable for communication in an ad hoc mode of a wireless LAN.

When the transmission destination of the input image is an external device connectable for communication without a network, the control unit 141 ends the series of steps without setting a new time in the measurement device 121. When the transmission destination of information is an external device connectable for communication via a wireless LAN or a wired LAN, the control unit 141 authenticates communication using the current time. When the transmission destination of information is an external device connectable for communication via facsimile, the control unit 141 transmits the current time as additional information of information to be transmitted. On the other hand, when the transmission destination of information is not an external device connectable for communication via a network (and is not an external storage device), the control unit 141 can transmit information to the transmission destination without using the time information. When it is determined that the transmission destination of the input image is an external device connectable for communication without a network and that the time measured by the measurement device 121 is inaccurate, the control unit 141 does not acquire the time information from the external device or does not set the time information acquired from the external device in the measurement device 121. In other words, even when the time measured by the measurement device 121 is inaccurate, the control unit 141 does not set a new time in the measurement device 121 when the transmission destination of the input image is an external device connectable for communication without a network. Accordingly, the information processing apparatus 100 can transmit the input image to the transmission destination without increasing the processing load and the processing time of the media reading process.

On the other hand, when the transmission destination of the input image is a device connectable for communication via a network, the control unit 141 determines whether communication through the first communication device 126 is possible (step S306). In other words, when the transmission destination of the input image is a device connectable for communication via a wireless LAN or a wired LAN or when the transmission destination of the input image is a device connectable for communication via facsimile, the control unit 141 determines whether communication through the first communication device 126 is possible. When the transmission destination of the input image is an external storage device, the control unit 141 determines whether communication through the first communication device 126 is possible. The control unit 141 receives a first state signal from the first communication device 126, and determines whether the received first state signal indicates that communication through the first communication device 126 is possible to determine whether communication through the first communication device 126 is possible.

When communication through the first communication device 126 is possible, the control unit 141 acquires time information indicating the current time through the first communication device 126 (step S307). The control unit 141 acquires time information indicating the current time from, for example, a network time protocol (NTP) server set in advance. The control unit 141 may acquire the time information from, for example, a mobile phone base station set in advance. The control unit 141 may acquire the time information from an artificial satellite or via a standard time radio wave.

Then, the control unit 141 sets the current time indicated by the acquired time information in the measurement device 121 (step S308), and then ends the series of steps.

On the other hand, when communication through the first communication device 126 is not possible in step S306, the control unit 141 notifies the user of a warning (step S309). The control unit 141 causes the display operation device 105 to display, for example, information indicating that the time measured by the measurement device 121 is inaccurate and/or information indicating that communication through the first communication device 126 is not possible. The control unit 141 further causes the display operation device 105 to display a request for setting the current time and/or a request for making a setting to acquire the current time. The control unit 141 may notify the user of a warning by outputting a voice from a speaker. The control unit 141 may notify the user of a warning by turning on a light-emitting diode (LED) or the like. The control unit 141 may notify the user of a warning by transmitting the warning to another communication device through the second communication device 127.

The control unit 141 acquires the current time by receiving designation of the current time from the user using the display operation device 105 or through the second communication device 127. Alternatively, the control unit 141 receives settings for acquiring the current time from the user using the display operation device 105 or through the second communication device 127. The control unit 141 receives, as the settings for acquiring the current time, the address of the NTP server or the mobile phone base station and/or communication settings or network settings for communicating with each device. Alternatively, the control unit 141 receives, as the settings for acquiring the current time, communication settings for communicating with an artificial satellite or reception settings for receiving a standard time radio wave. Accordingly, the control unit 141 acquires the time information from the NTP server, the mobile phone base station, the artificial satellite, or the standard time radio wave.

Then, the control unit 141 sets the time indicated by the acquired time information in the measurement device 121 (step S310), and then ends the series of steps.

As described above, when the transmission destination of information is a device connectable for communication via a wireless LAN or a wired LAN, the control unit 141 authenticates communication using the current time. When the transmission destination of information is a device connectable for communication via facsimile, the control unit 141 transmits the current time as additional information of the information to be transmitted. When the transmission destination of information is an external storage device, the control unit 141 transmits the current time as additional information of the information to be transmitted. When the transmission destination of the input image is a device connectable for communication via a network or when the transmission destination of the input image is an external storage device, the control unit 141 can appropriately transmit the input image to the transmission destination by setting the current time in the measurement device 121.

When communication through the first communication device 126 is possible, the control unit 141 acquires time information through the first communication device 126, and sets the acquired time information in the measurement device 121. When communication through the first communication device 126 is not possible, the control unit 141 notifies the user of a warning. The operation of acquiring time information through the first communication device 126 and setting the acquired time information in the measurement device 121 when communication through the first communication device 126 is possible, and notifying the user of a warning when communication through the first communication device 126 is not possible is an example of a predetermined operation for correcting a time drift. Accordingly, the information processing apparatus 100 can set the current time without involvement by the user when the time information can be automatically acquired, and can notify the user when the time information cannot be automatically acquired, ensuring that the current time can be set. Thus, the information processing apparatus 100 can reliably set the current time while improving user convenience.

Further, the control unit 141 determines whether to set the current time in the measurement device 121 again according to the type of a communication device through which communication is possible among the first communication device 126 and the second communication device 127. Accordingly, in the information processing apparatus 100, whether the current time is set in the measurement device 121 depends on whether an accurate time is to be used to transmit the input image. Thus, the information processing apparatus 100 can transmit the input image to the transmission destination without increasing the processing load and the processing time of the media reading process.

In step S306, instead of or in addition to determining whether communication through the first communication device 126 is possible, the control unit 141 may determine whether communication through the second communication device 127 is possible. In this case, the second communication device 127 is an example of the communication unit. The control unit 141 receives a second state signal from the second communication device 127, and determines whether the received second state signal indicates that communication through the second communication device 127 is possible to determine whether communication through the second communication device 127 is possible. When communication through the second communication device 127 is possible, in step S307, the control unit 141 acquires the time information from a communicably connected device through the second communication device 127. In step S309, the control unit 141 receives the setting from the user using the display operation device 105 or through the first communication device 126. The control unit 141 receives, for example, communication settings (such as Bluetooth® pairing settings or reconnection settings) for communication through the second communication device 127.

Also in this case, the information processing apparatus 100 can set the current time without involvement by the user when the time information can be automatically acquired, and can notify the user when the time information cannot be automatically acquired, ensuring that the current time can be set. Thus, the information processing apparatus 100 can reliably set the current time in the measurement device 121 while improving user convenience.

The processing of step S304 and/or step S305 may be omitted. The processing of steps S306 and S307 or the processing of steps S306, S309, and S310 may be omitted. The processing of step S301 may be executed immediately before the processing of step S306. In other words, when the transmission destination of the input image is a device connectable for communication without a network, the control unit 141 may omit the determination of whether the first condition is satisfied.

As described above in detail, when the time measured by the measurement device 121 is inaccurate, the information processing apparatus 100 acquires time information through the first communication device 126 in a case where communication through the first communication device 126 is possible. When the time measured by the measurement device 121 is inaccurate, in a case where communication through the first communication device 126 is not possible, the information processing apparatus 100 notifies the user of a warning. Accordingly, the information processing apparatus 100 can reliably set the current time in the measurement device 121 while improving user convenience, and can appropriately manage the time to be measured.

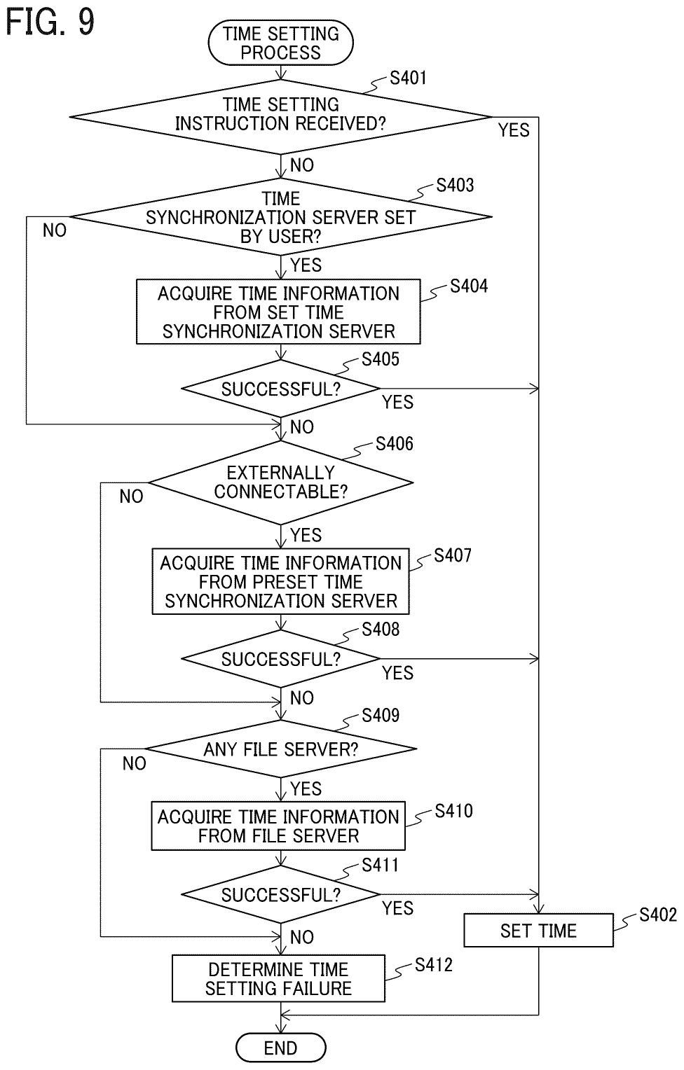

FIG. 9 is a flowchart illustrating an example of the operations of a time setting process performed by the information processing apparatus 100 according to a second embodiment of the present disclosure.

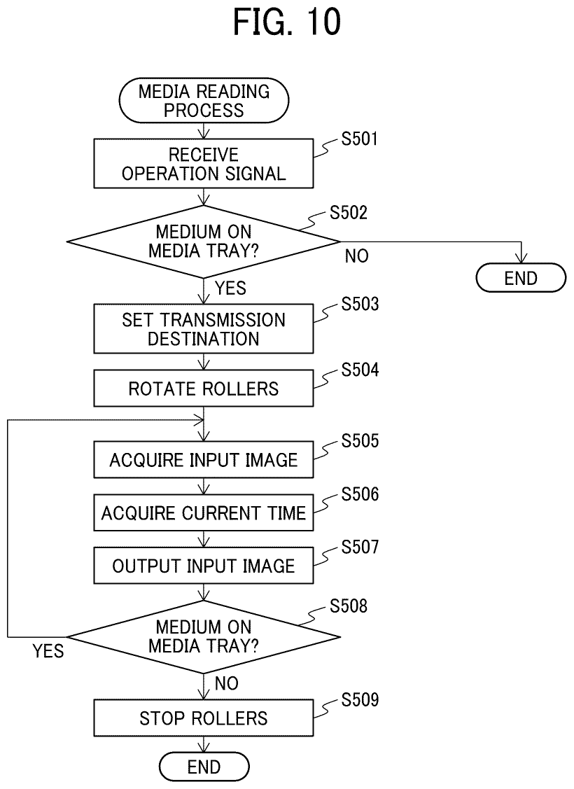

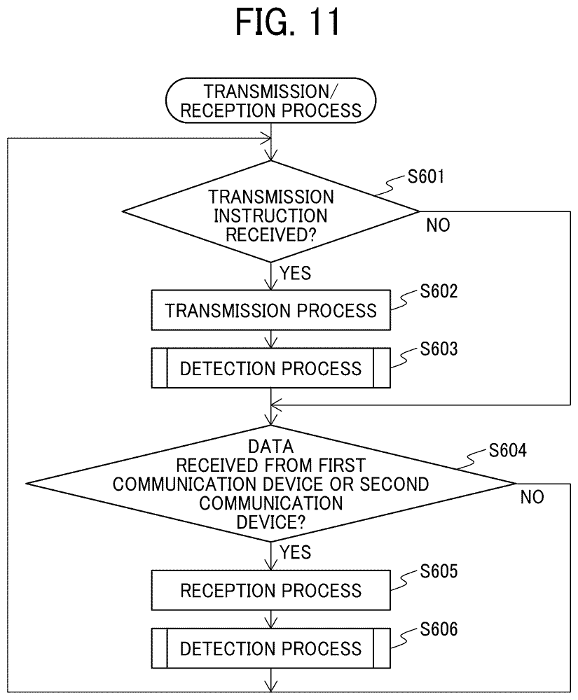

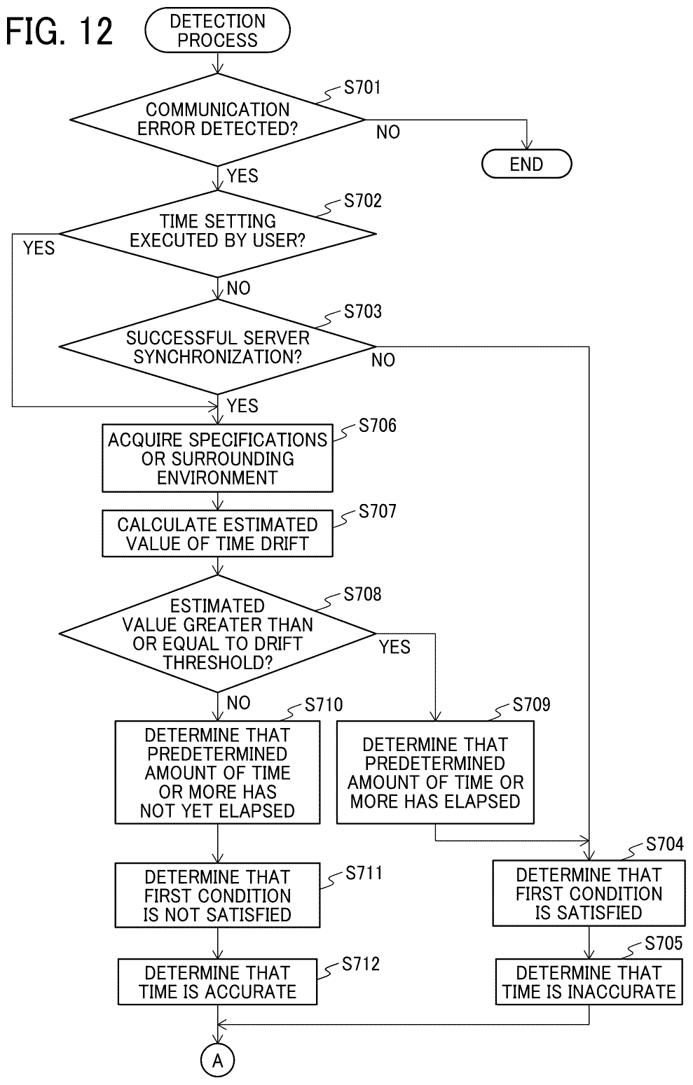

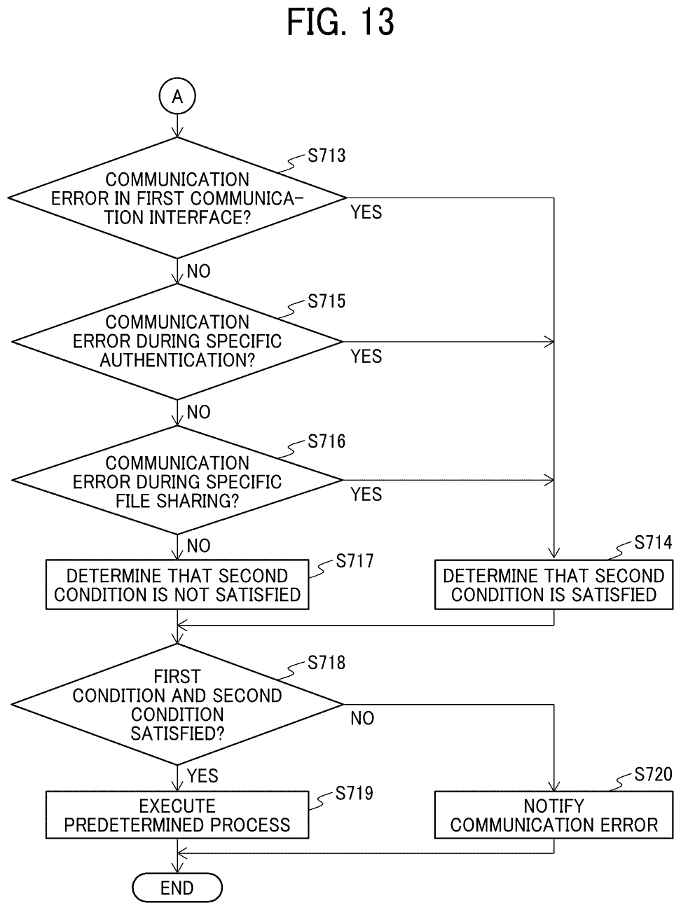

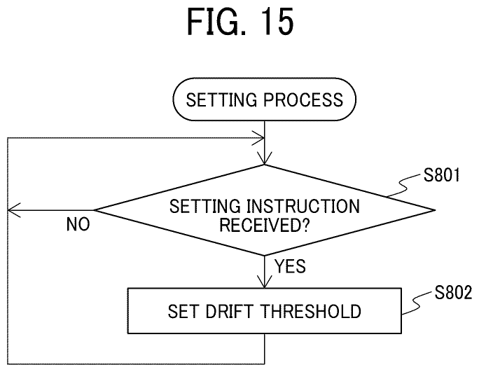

The time setting process illustrated in FIG. 9, a media reading process described below with reference to FIGS. 10 and 11, a detection process described below with reference to FIGS. 12 and 13, and a setting process described below with reference to FIG. 15 are executed in place of the media reading process illustrated in FIG. 7.

An example of the operations of the time setting process performed by the information processing apparatus 100 according to the second embodiment will be described hereinafter with reference to the flowchart illustrated in FIG. 9. The flow of the operations described below is executed by, for example, the second processing circuit 140 in cooperation with the components of the information processing apparatus 100 according to the programs stored in the second storage device 130 in advance. The time setting process is executed periodically. The time setting process may be executed at the time of activation of the information processing apparatus 100.

First, the control unit 141 determines whether a time setting instruction has been received from the user (step S401). When the user inputs a time setting instruction using the display operation device 105 or another communication device and a time setting instruction signal is received from the display operation device 105, the first communication device 126, or the second communication device 127, the control unit 141 receives the time setting instruction. The time setting instruction signal is a signal for instructing the time setting, and includes the time (current time) designated by the user.

When the time setting instruction signal has been received, the control unit 141 sets the current time designated by the received time setting instruction signal in the measurement device 121, stores setting time information indicating a setting time at which the current time is set in the measurement device 121 in the second storage device 130 (step S402), and then ends the series of steps. The setting time information is information for measuring the time elapsed since the current time was set in the measurement device 121, and is preferably calculated using a device other than the measurement device 121. The control unit 141 calculates the setting time information based on, for example, the number or the like of counts of the CPU clock supplied to the second processing circuit 140 when the current time is set in the measurement device 121. In this case, the control unit 141 periodically monitors the overflow of the CPU clock, and calculates the elapsed time from the time indicated by the setting time information to the current time.

On the other hand, when the time setting instruction signal has not been received, the control unit 141 determines whether a time synchronization server has been set in the information processing apparatus 100 by the user (step S403). The time synchronization server is an example of a server that distributes time information, and is, for example, an NTP server. The time synchronization server may be, for example, a mobile phone base station, an artificial satellite, or a standard time radio wave transmitter. When the time synchronization server has not been set by the user, the control unit 141 causes the process to proceed to step S406.

On the other hand, when the time synchronization server has been set by the user, the control unit 141 acquires time information indicating the current time from the set time synchronization server through the first communication device 126 (step S404).

Then, the control unit 141 determines whether the acquisition of the time information from the set time synchronization server is successful (step S405). When communication with the set time synchronization server is successful and the time information is successfully acquired, the control unit 141 determines that the acquisition of the time information is successful. When communication with the set time synchronization server is not successful and the time information is not successfully acquired, the control unit 141 determines that the acquisition of the time information has failed.

When the acquisition of the time information is successful, the control unit 141 sets the current time indicated by the acquired time information in the measurement device 121, stores the setting time information in the second storage device 130 (step S402), and then ends the series of steps.

On the other hand, when the acquisition of the time information has failed, the control unit 141 determines whether communication through the first communication device 126 is possible (step S406). The control unit 141 receives a first state signal from the first communication device 126, and determines whether the received first state signal indicates that communication through the first communication device 126 is possible to determine whether communication through the first communication device 126 is possible. When communication through the first communication device 126 is not possible, the control unit 141 causes the process to proceed to step S409.

On the other hand, when communication through the first communication device 126 is possible, the control unit 141 acquires the time information from a preset time synchronization server through the first communication device 126 (step S407). The preset time synchronization server is an example of a server that distributes time information, and is a time synchronization server set in the information processing apparatus 100 before shipment of the information processing apparatus 100. The time synchronization server is, for example, an NTP server. The time synchronization server may be, for example, a mobile phone base station, an artificial satellite, or a standard time radio wave transmitter.

The preset time synchronization server allows the information processing apparatus 100 to appropriately acquire the time information even when the time information is not successfully acquired from the time synchronization server set by the user for some reason.

Then, the control unit 141 determines whether the acquisition of the time information from the preset time synchronization server is successful (step S408). When communication with the preset time synchronization server is successful and the time information is successfully acquired, the control unit 141 determines that the acquisition of the time information is successful. When communication with the preset time synchronization server is not successful and the time information is not successfully acquired, the control unit 141 determines that the acquisition of the time information has failed.

When the acquisition of the time information is successful, the control unit 141 sets the current time indicated by the acquired time information in the measurement device 121, stores the setting time information in the second storage device 130 (step S402), and then ends the series of steps.

On the other hand, when the acquisition of the time information has failed, the control unit 141 determines whether any file server has previously been connected to the information processing apparatus 100 (step S409). The file server is an example of a server that distributes time information, and is, for example, a server message block (SMB) server. The file server may be, for example, a software composition analysis (SCA) server or an apparatus set as a transmission destination of an input image generated by the information processing apparatus 100. When no file server has previously been connected to the information processing apparatus 100, the control unit 141 causes the process to proceed to step S412.

On the other hand, when a file server has previously been connected to the information processing apparatus 100, the control unit 141 acquires the time information from the previously connected file server through the first communication device 126 or the second communication device 127 (step S410). The control unit 141 transmits a write request signal to the file server through the first communication device 126 or the second communication device 127 to make a request to write predetermined data. The write request signal includes any data. In response to receipt of the write request signal, the file server stores the data included in the received write request signal in a storage device, and transmits a write response signal to the information processing apparatus 100. The write response signal includes the time (time stamp) at which the data is written to the storage device. The control unit 141 receives the write response signal from the file server through the first communication device 126 or the second communication device 127, and acquires the time included in the received write response signal as time information. The control unit 141 may transmit, separately from the write request signal, a time request signal for making a request to acquire the time at which the data is written to the storage device, and the file server may transmit, separately from the write response signal, a time response signal indicating the time (time stamp) at which the data is written to the storage device to the information processing apparatus 100.

The file server allows the information processing apparatus 100 to appropriately acquire the time information even when the time information is not successfully acquired from the time synchronization server set by the user and/or the preset time synchronization server for some reason. Even when the information processing apparatus 100 fails to communicate with a time synchronization server, the information processing apparatus 100 can appropriately acquire the time information by using a general-purpose file server having no time synchronization function.

Then, the control unit 141 determines whether the acquisition of the time information from the file server is successful (step S411). When communication with the file server is successful and the time information is successfully acquired, the control unit 141 determines that the acquisition of the time information is successful. When communication with the file server is not successful and the time information is not successfully acquired, the control unit 141 determines that the acquisition of the time information has failed.

When the acquisition of the time information is successful, the control unit 141 sets the current time indicated by the acquired time information in the measurement device 121, stores the setting time information in the second storage device 130 (step S402), and then ends the series of steps.

On the other hand, when the acquisition of the time information has failed, the control unit 141 determines that the setting of the time information has failed (step S412), and then ends the series of steps. In this case, the control unit 141 may cause the display operation device 105 to display information indicating the failure of the setting of the time information or transmit the information to another communication device through the first communication device 126 or the second communication device 127 to notify the user of the failure of the setting of the time information.

At least one set of operations from among step S401, steps S403 to S405, steps S406 to S408, and steps S409 to S411 is executed, and the other sets of operations may be omitted.

FIG. 10 is a flowchart illustrating an example of the operations of a media reading process performed by the information processing apparatus 100 according to the second embodiment.

An example of the operations of the media reading process performed by the information processing apparatus 100 according to the second embodiment will be described hereinafter with reference to the flowchart illustrated in FIG. 10. The flow of the operations described below is executed by, for example, the second processing circuit 140 in cooperation with the components of the information processing apparatus 100 according to the programs stored in the second storage device 130 in advance. The processing of steps S501 to S503, S504 to S506, S508, and S509 are similar to the processing of steps S201 to S203, S205 to S207, S209, and S210 in FIG. 7, and thus a description thereof will be omitted. The following describes the processing of step S507.

The control unit 141 transmits a transmission instruction to the transmission/reception unit 144 to transmit the acquired input image and current time to the transmission destination set by the transmission destination setting unit 142 in step S203 (corresponding to step S503) through the first communication device 126 or the second communication device 127 (step S507). The transmission instruction includes the data to be transmitted, namely, the input image, the current time, information indicating the transmission destination, and information indicating a communication device to be used (i.e., the first communication device 126 or the second communication device 127). In a transmission/reception process described below, the transmission/reception unit 144 receives a transmission signal and transmits the input image and the current time to the transmission destination through the first communication device 126 or the second communication device 127 according to the received transmission signal. When the transmission destination is a device connectable for communication via a network, in particular, a wireless LAN or a wired LAN, the transmission/reception unit 144 authenticates communication using the current time and transmits the input image to the transmission destination. When the transmission destination is a device connectable for communication via facsimile, the transmission/reception unit 144 transmits the current time to the transmission destination as additional information of the input image to be transmitted, together with the input image. When the transmission destination is an external storage device, the transmission/reception unit 144 transmits the current time to the transmission destination as additional information of the input image to be transmitted, together with the input image. The device set as the transmission destination stores and manages the received input image together with the current time.

FIG. 11 is a flowchart illustrating an example of the operations of a transmission/reception process according to the second embodiment.

An example of the operations of a transmission/reception process performed by the information processing apparatus 100 according to the second embodiment will be described hereinafter with reference to the flowchart illustrated in FIG. 11. The flow of the operations described below is executed by, for example, the second processing circuit 140 in cooperation with the components of the information processing apparatus 100 according to the programs stored in the second storage device 130 in advance. The transmission/reception process is executed after the activation of the information processing apparatus 100.

First, the transmission/reception unit 144 determines whether a new transmission instruction has been received (step S601). The transmission instruction is transmitted by the control unit 141 in step S507 in FIG. 10, for example. The transmission instruction may be transmitted by any hardware module other than the control unit 141 or any software module in any process other than the media reading process. The transmission instruction may be transmitted to make an instruction to transmit any data such as information for user or device authentication or data for file sharing, for example. When no new transmission instruction has been received, the transmission/reception unit 144 causes the process to proceed to step S604.

On the other hand, when a new transmission instruction has been received, the transmission/reception unit 144 transmits data designated in the transmission instruction to a transmission destination designated in the transmission instruction through a communication device designated in the transmission instruction (step S602).

Then, the detection unit 145 executes a detection process (step S603). In the detection process, the detection unit 145 detects a communication error with an external device. In response to the detection of a communication error, the control unit 141 executes a predetermined operation. The detection process will be described in detail below.

Then, the transmission/reception unit 144 determines whether new data has been received from the first communication device 126 or the second communication device 127 (step S604). When a signal is received from an external device, the first communication device 126 or the second communication device 127 transmits data included in the received signal to the transmission/reception unit 144. When no new data has been received from the first communication device 126 or the second communication device 127, the transmission/reception unit 144 returns the process to step S601.

On the other hand, when new data has been received from the first communication device 126, the transmission/reception unit 144 executes a reception process corresponding to the received data (step S605). For example, in a case where a notification indicating the completion of the reception of the input image has been received from the transmission destination of the input image, the transmission/reception unit 144 transfers the received notification to the control unit 141. For example, in a case where information for user or device authentication has been received, the transmission/reception unit 144 transfers the received information to an authentication module, and the authentication module executes user or device authentication based on the transferred information. In a case where data for file sharing has been received, the transmission/reception unit 144 transfers the received data to a file sharing module, and the file sharing module stores the transferred data in the second storage device 130.

Then, the detection unit 145 executes the detection process (step S606), and then returns the process to step S601.

FIGS. 12 and 13 are a flowchart illustrating an example of the operations of the detection process according to the second embodiment.

The detection process is executed in steps S603 and S606 in FIG. 11.

First, the detection unit 145 determines whether a communication error has occurred during communication with an external device through the first communication device 126 or the second communication device 127. When it is determined that a communication error has occurred, the detection unit 145 detects the communication error with the external device (step S701). When a packet received from the external device or a network device through the first communication device 126 or the second communication device 127 indicates that a communication error has occurred, the detection unit 145 determines that a communication error has occurred during communication with the external device through the first communication device 126 or the second communication device 127. For example, when a packet received from the information processing apparatus 100 is missing or when information such as time information included in the received packet is not correct, the external device determines that a communication error has occurred, and transmits a packet indicating that the communication error has occurred. For example, in user authentication such as Kerberos authentication in Active Directory® or the like, when the time drift between the server and the client is greater than or equal to a predetermined time (e.g., five minutes), it is determined that a communication error has occurred. In file sharing using Samba on macOS® or the like, when the time drift between the server and the client is greater than or equal to five minutes, it may be determined that a communication error has occurred. In Windows® authentication as well, when there is a time drift between devices communicating with each other, it may be determined that a communication error has occurred. When no communication error with an external device is detected, the detection unit 145 ends the series of steps without performing any process.

On the other hand, when the detection unit 145 detects a communication error with an external device, the control unit 141 determines whether the time setting has been executed according to an instruction from the user after the activation of the information processing apparatus 100 (step S702). When a time setting instruction is received from the user in step S401 in FIG. 9 and the current time is set in the measurement device 121 after the activation of the information processing apparatus 100, the control unit 141 determines that the time setting has been executed according to an instruction from the user. On the other hand, when no time setting instruction is received from the user in step S401 in FIG. 9 after the activation of the information processing apparatus 100, the control unit 141 determines that the time setting has not been executed according to an instruction from the user. When the time setting has been executed according to an instruction from the user after the activation of the information processing apparatus 100, the control unit 141 causes the process to proceed to step S706.

On the other hand, when the time setting has not been executed according to an instruction from the user after the activation of the information processing apparatus 100, the control unit 141 determines whether synchronization with a server that distributes time information is successful after the activation of the information processing apparatus 100 (step S703). When the acquisition of the time information from the set time synchronization server, the preset time synchronization server, or the file server is successful in step S405, S408, or S411 in FIG. 9 and the current time is set in the measurement device 121 after the activation of the information processing apparatus 100, the control unit 141 determines that the synchronization with the server that distributes time information is successful. On the other hand, when the acquisition of the time information from the set time synchronization server, the preset time synchronization server, or the file server is not successful in step S405, S408, or S411 in FIG. 9 after the activation of the information processing apparatus 100, the control unit 141 determines that the synchronization with the server that distributes time information is not successful.

When the synchronization with the server that distributes time information is not successful after the activation of the information processing apparatus 100, the control unit 141 determines that a first condition in which there is a possibility that the time measured by the measurement device 121 drifts is satisfied (step S704). The first condition is a condition for determining that there is a possibility that the time measured by the measurement device 121 drifts.

As described above, the control unit 141 determines that the first condition is satisfied when the time setting has not been executed by the user after the activation of the information processing apparatus 100 or when the synchronization with the server that distributes time information is not successful after the activation of the information processing apparatus 100. Accordingly, the information processing apparatus 100 can accurately determine whether there is a possibility that the time measured by the measurement device 121 drifts.

Then, the control unit 141 determines that the time measured by the measurement device 121 is inaccurate (step S705), and then causes the process to proceed to step S713.

On the other hand, after the activation of the information processing apparatus 100, when the time setting has been executed according to an instruction from the user or when the synchronization with the server that distributes time information is successful, the control unit 141 acquires the specifications or the surrounding environment of the measurement device 121 (step S706). The specifications of the measurement device 121 are, for example, specifications indicating the accuracy of the time measured by the measurement device 121. The accuracy of the time is, for example, the maximum value of an error such as a daily error, a monthly error, or a yearly error. The control unit 141 reads and acquires the specifications of the measurement device 121 from the measurement device 121. The specifications of the measurement device 121 may be stored in the second storage device 130 in advance, and the control unit 141 may read and acquire the specifications of the measurement device 121 from the second storage device 130. The surrounding environment of the measurement device 121 is, for example, the ambient temperature (environmental temperature) of the measurement device 121. The control unit 141 receives a temperature signal from the temperature sensor 123, and acquires the temperature indicated by the received temperature signal. The surrounding environment of the measurement device 121 may be the ambient humidity of the measurement device 121, and the control unit 141 may acquire the ambient humidity of the measurement device 121 from a humidity sensor.

Then, the control unit 141 calculates an estimated value of time drift in the time measured by the measurement device 121, based on the specifications or the surrounding environment of the measurement device 121 (step S707). The information processing apparatus 100 stores, in the second storage device 130 in advance, an equation or a table indicating the relationship between the specifications and/or the surrounding environment of the measurement device 121 and a time error per unit time. The control unit 141 identifies, from the equation or the table stored in the second storage device 130, the time error per unit time corresponding to the specifications and/or the surrounding environment of the measurement device 121. The control unit 141 calculates the elapsed time from the last time the time was set in step S402 in FIG. 9 to the current time. The control unit 141 multiplies the calculated elapsed time by the identified time error per unit time to calculate an estimated value of time drift in the time measured by the measurement device 121.

Then, the control unit 141 determines whether the calculated estimated value of the time drift is greater than or equal to a drift threshold (step S708). The drift threshold is set in the second storage device 130 in advance. The drift threshold is set to, for example, a minimum value of time drift at which the external device determines that the time information included in the received packet is not correct.

When the estimated value of the time drift is greater than or equal to the drift threshold, the control unit 141 determines that a predetermined amount of time or more has elapsed since the time setting was executed by the user or since the synchronization with the server that distributes time information was successful (step S709).

Then, the control unit 141 determines that the first condition is satisfied (step S704).

As described above, the control unit 141 determines whether the first condition is satisfied, based on the elapsed time from the previous time the time was set in the measurement device 121. The control unit 141 determines that the first condition is satisfied when a predetermined amount of time or more has elapsed since the time setting was executed or since the synchronization with the server that distributes time information was successful. Accordingly, the information processing apparatus 100 can accurately determine whether there is a possibility that the time measured by the measurement device 121 drifts.

Then, the control unit 141 determines that the time measured by the measurement device 121 is inaccurate (step S705), and then causes the process to proceed to step S713.

On the other hand, when the estimated value of the time drift is less than the drift threshold, the control unit 141 determines that the predetermined amount of time or more has not yet elapsed since the time setting was executed by the user or since the synchronization with the server that distributes time information was successful (step S710).

Then, the control unit 141 determines that the first condition is not satisfied (step S711).

As described above, the control unit 141 determines whether the first condition is satisfied by comparing the estimated value of the time drift with the drift threshold. Accordingly, the information processing apparatus 100 can accurately determine whether the first condition is satisfied, that is, whether there is a possibility that the time measured by the measurement device 121 drifts.

In particular, the control unit 141 determines whether the first condition is satisfied, based on the specifications or the surrounding environment of the measurement device 121. Accordingly, the information processing apparatus 100 can accurately determine whether the first condition is satisfied, that is, whether there is a possibility that the time measured by the measurement device 121 drifts.

Then, the control unit 141 determines that the time measured by the measurement device 121 is accurate (step S712).

As described above, the control unit 141 determines whether the time measured by the measurement device 121 is accurate, based on whether the first condition is satisfied. Accordingly, the information processing apparatus 100 can accurately determine whether the time measured by the measurement device 121 is accurate.

Then, the control unit 141 determines whether a communication interface in which the communication error has occurred is a first communication interface (step S713). The communication interface includes a communication device in the information processing apparatus 100 and a communication destination. A communication interface in which a communication error may occur due to time drift is set in advance as the first communication interface. For example, communication or the like with a general-purpose module via a wireless LAN is set as the first communication interface. The general-purpose module is, for example, a module that is not provided by the provider of the information processing apparatus 100, that is, a module provided by a provider other than the provider of the information processing apparatus 100. For example, communication or the like via a wireless LAN may be set as the first communication interface.

When the communication interface in which the communication error has occurred is the first communication interface, the control unit 141 determines that a second condition in which there is a possibility that the communication error is caused by time drift is satisfied (step S714), and then causes the process to proceed to step S718. The second condition is a condition for determining that there is a possibility that the communication error is caused by time drift. The information processing apparatus 100 can accurately determine whether there is a possibility that the communication error is caused by time drift, based on the type of the communication interface in which the communication error has occurred.

On the other hand, when the communication interface in which the communication error has occurred is not the first communication interface, the control unit 141 determines whether the communication error has occurred during authentication using a specific user management method (step S715). Examples of the authentication using a specific user management method include authentication in Active Directory®.

When the communication error has occurred during authentication using a specific user management method, the control unit 141 determines that the second condition is satisfied (step S714), and then causes the process to proceed to step S718. The information processing apparatus 100 can accurately determine whether there is a possibility that the communication error is caused by time drift, based on whether the communication error has occurred during authentication using a specific user management method.

On the other hand, when the communication error has not occurred during authentication using a specific user management method, the control unit 141 determines whether the communication error has occurred during file sharing using specific hardware or software (step S716). Examples of the file sharing using specific hardware or software include file sharing using Samba on macOS® and file sharing in Time Capsule manufactured by Apple Inc. For example, the control unit 141 acquires information indicating hardware or software of a device in which the communication error has occurred, from a network management device that manages devices connected to the network, based on the IP address, the media access control (MAC) address, or the like of the device in which the communication error has occurred. In another example, the control unit 141 may use a method such as Passive OS fingerprinting to acquire, from a device in which the communication error has occurred, information indicating the hardware or software of the device.

When the communication error has occurred during file sharing using specific hardware or software, the control unit 141 determines that the second condition is satisfied (step S714), and then causes the process to proceed to step S718. The information processing apparatus 100 can accurately determine whether there is a possibility that the communication error is caused by time drift, based on whether the communication error has occurred during file sharing using specific hardware or software.

On the other hand, when the communication error has not occurred during file sharing using specific hardware or software, the control unit 141 determines that the second condition is not satisfied (step S717).

Then, the control unit 141 determines whether the first condition is satisfied and whether the second condition is satisfied (step S718).

When both the first condition and the second condition are satisfied, the control unit 141 executes a predetermined operation for correcting the time drift (step S719), and then ends the series of steps. In the predetermined operation, for example, the control unit 141 notifies the user that there is a possibility that the communication error is caused by factors including time drift and/or sends a notification prompting the user to execute the time setting. In the following description, the notification indicating that there is a possibility that the communication error is caused by factors including time drift and/or the notification prompting the user to execute the time setting may be referred to as a first notification. The control unit 141 issues the first notification by causing the display operation device 105 to display information indicating that there is a possibility that the communication error is caused by factors including time drift and/or information prompting the time setting or by transmitting the information to another communication device through the first communication device 126 or the second communication device 127.

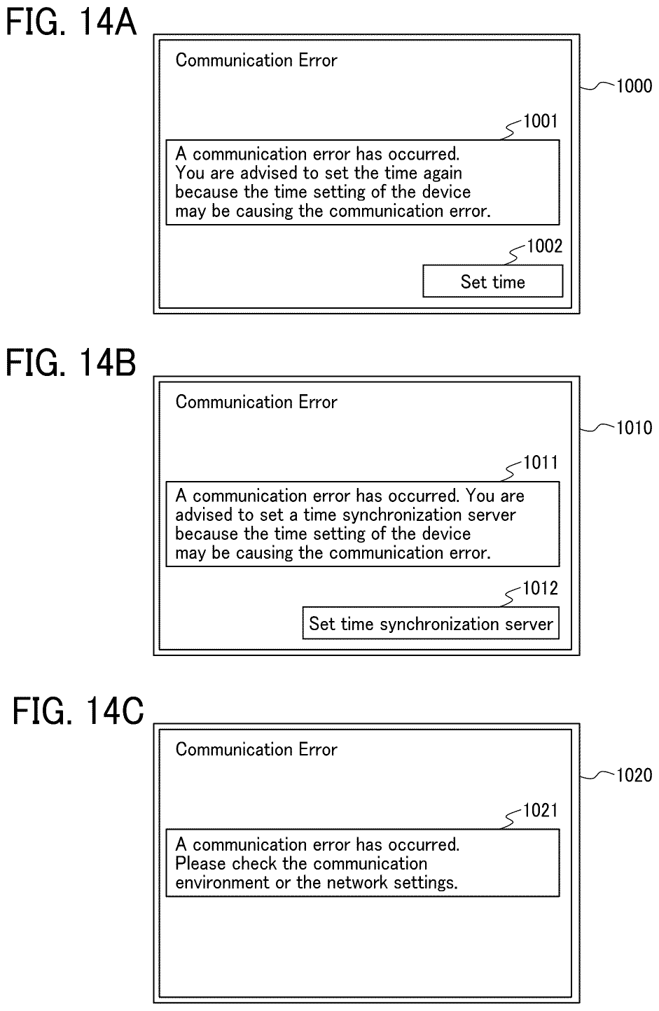

FIG. 14A illustrates an example of a first notification screen that displays the first notification.

As illustrated in FIG. 14A, a first notification screen 1000 displays a first text 1001 and a first button 1002. The first text 1001 indicates that a communication error has occurred, that there is a possibility that the communication error is caused by factors including time drift, and that the time setting is prompted. The first button 1002 is a button for displaying a screen for setting the time. The first text 1001 allows the user to recognize with certainty that a time drift may have occurred. By pressing the first button 1002, the user can easily set the time. Thus, the information processing apparatus 100 can improve user convenience.

When a server that distributes time information has not been set or when a communication connection to an external network is possible, in the predetermined operation, the control unit 141 may send a notification prompting the setting of a server that distributes time information. In the following description, the notification prompting the setting of a server that distributes time information may be referred to as a second notification. The control unit 141 issues the second notification by causing the display operation device 105 to display information prompting the setting of a server that distributes time information or by transmitting the information to another communication device through the first communication device 126 or the second communication device 127.

FIG. 14B illustrates an example of a second notification screen that displays the second notification.

As illustrated in FIG. 14B, a second notification screen 1010 displays a second text 1011 and a second button 1012. The second text 1011 indicates that a communication error has occurred and that the setting of a server that distributes time information is prompted. The second button 1012 is a button for displaying a screen for setting a server that distributes time information. The second text 1011 allows the user to recognize with certainty that a time drift may have occurred. By pressing the second button 1012, the user can easily set a server that distributes time information. Thus, the information processing apparatus 100 can improve user convenience.

In the predetermined operation, the control unit 141 may acquire time information from a device to which an input image generated by the information processing apparatus 100 is to be transmitted or from another image reading apparatus. The device to which the input image is to be transmitted is a device such as a file server set as the transmission destination of the input image. The other image reading apparatus is an image reading apparatus such as another scanner connected to a network to which the information processing apparatus 100 is connected for communication. The control unit 141 transmits a request signal to a device to which the input image is to be transmitted or another image reading apparatus through the first communication device 126 or the second communication device 127 to make a request to acquire time information. The control unit 141 receives and acquires, from the device to which the request signal is transmitted, time information managed by the device through the first communication device 126 or the second communication device 127. Then, the control unit 141 sets the current time indicated by the acquired time information in the measurement device 121, and stores the setting time information in the second storage device 130. Accordingly, the information processing apparatus 100 can set the time information without involvement by the user, and can improve user convenience.

On the other hand, when any one of the first condition and the second condition is not satisfied, the control unit 141 notifies the user of the occurrence of a communication error (step S720), and then ends the series of steps. In the following description, the notification of the occurrence of a communication error may be referred to as a third notification. The control unit 141 issues the third notification by causing the display operation device 105 to display information indicating that a communication error has occurred or by transmitting the information to another communication device through the first communication device 126 or the second communication device 127.

FIG. 14C illustrates an example of a third notification screen that displays the third notification.

As illustrated in FIG. 14C, a third notification screen 1020 displays a third text 1021. The third text 1021 indicates that a communication error has occurred and that the checking of the communication environment or the network settings is prompted. The third text 1021 does not indicate that there is a possibility that the communication error is caused by factors including time drift, that the time setting is prompted, and that the setting of a server that distributes time information is prompted.

As described above, when a communication error is detected by the detection unit 145 and both the first condition and the second condition are satisfied, that is, when it is determined that the time measured by the measurement device 121 is inaccurate and the second condition is satisfied, the control unit 141 executes the predetermined operation. Accordingly, the information processing apparatus 100 can take appropriate measures when there is a possibility that a communication error has occurred due to the occurrence of a time drift in the measurement device 121, and can increase the possibility that the problem will be solved early.

On the other hand, when a communication error is detected by the detection unit 145, in a case where the first condition is not satisfied, that is, in a case where it is determined that the time measured by the measurement device 121 is accurate, or in a case where the second condition is not satisfied, the control unit 141 does not execute the predetermined operation. Accordingly, the information processing apparatus 100 can avoid taking incorrect measures when the occurrence of the communication error is not due to the occurrence of a time drift in the measurement device 121, and can reduce the possibility that the problem will be solved late. In addition, the information processing apparatus 100 can avoid sending an inappropriate notification to the user, which makes the user feel less stressed. Thus, the information processing apparatus 100 can improve user convenience.

At least one set of operations from among step S702, steps S703, and steps S706 to S710 is executed, and the other sets of operations may be omitted.

Instead of performing the processing of steps S702 and S703, the control unit 141 may determine whether the time setting has been executed after the activation of the information processing apparatus 100. In a case where the current time is set in the measurement device 121 in step S402 in FIG. 9 after the activation of the information processing apparatus 100, the control unit 141 determines that the time setting has been executed. In a case where the current time is not set in the measurement device 121 in step S402 in FIG. 9 after the activation of the information processing apparatus 100, the control unit 141 determines that the time setting has not been executed. When the time setting has not been executed after the activation of the information processing apparatus 100, the control unit 141 determines that the first condition is satisfied. When the time setting has been executed after the activation of the information processing apparatus 100, the control unit 141 causes the process to proceed to step S706. The information processing apparatus 100 can accurately determine whether there is a possibility that the time measured by the measurement device 121 drifts, based on whether the time setting has been executed after the activation of the information processing apparatus 100.

Instead of performing the processing of steps S706 to S710, the control unit 141 may determine whether a predetermined fixed amount of time has elapsed since the time setting was executed by the user or since the synchronization with the server that distributes time information was successful. In this case, the control unit 141 determines that the first condition is satisfied when the predetermined amount of time has elapsed since the time setting was executed by the user or since the synchronization with the server that distributes time information was successful. On the other hand, when the predetermined amount of time has not elapsed since the time setting was executed by the user or since the synchronization with the server that distributes time information was successful, the control unit 141 determines that the first condition is not satisfied.

Instead of determining in step S713 whether the communication interface in which the communication error has occurred is the first communication interface, the control unit 141 may determine whether the communication interface in which the communication error has occurred is a second communication interface. A communication interface in which the occurrence of the communication error is not likely to be due to time drift is set in advance as the second communication interface. For example, communication via USB or communication or the like with a special module (a module provided by the provider of the information processing apparatus 100) via a wireless LAN is set as the second communication interface. When the communication interface in which the communication error has occurred is not the second communication interface, the control unit 141 determines that the second condition is satisfied. When the communication interface in which the communication error has occurred is the second communication interface, the control unit 141 causes the process to proceed to step S715. The information processing apparatus 100 can accurately determine whether there is a possibility that the communication error is caused by time drift, based on the type of the communication interface in which the communication error has occurred. When the communication interface in which the communication error has occurred is the second communication interface, the control unit 141 may cause the process to proceed to step S717 and determine that the second condition is not satisfied. In this case, when the communication interface in which the communication error has occurred is not the second communication interface, the control unit 141 may cause the process to proceed to step S715.

Further, in a case where it is determined that the first condition is not satisfied in step S711 and it is determined that the time measured by the measurement device 121 is accurate in step S712, the control unit 141 may cause the process to proceed to step S720.

FIG. 15 is a flowchart illustrating an example of the operations of a setting process according to the second embodiment.

An example of the operations of a setting process performed by the information processing apparatus 100 according to the second embodiment will be described hereinafter with reference to the flowchart illustrated in FIG. 15. The flow of the operations described below is executed by, for example, the second processing circuit 140 in cooperation with the components of the information processing apparatus 100 according to the programs stored in the second storage device 130 in advance. The setting process is executed after the activation of the information processing apparatus 100.

First, the threshold setting unit 143 waits until an instruction to set a drift threshold is input by the user using the display operation device 105 or another communication device and a setting signal indicating the instruction to set a drift threshold is received from the display operation device 105, the first communication device 126, or the second communication device 127 (step S801). The setting signal includes a value of the drift threshold designated by the user using the display operation device 105 or another communication device.

Then, the threshold setting unit 143 stores (sets) the drift threshold included in the setting signal in the second storage device 130 (step S802), and then returns the process to step S801. Accordingly, subsequently, in step S708 in FIG. 12, the control unit 141 uses the drift threshold set by the user to determine whether a predetermined amount of time or more has elapsed since the time setting was executed or since the synchronization with the server that distributes time information was successful. The information processing apparatus 100 can change the drift threshold according to, for example, the application of the information processing apparatus 100, which differs from user to user, and can accurately determine whether there is a possibility that the time measured by the measurement device 121 drifts.

As described above in detail, when a communication error is detected, there is a possibility of time drift, and there is a possibility that the communication error is caused by time drift, the information processing apparatus 100 executes a predetermined operation for correcting the time drift. Accordingly, in a case where a communication error caused by time drift has occurred, the information processing apparatus 100 can correct the time drift, and can appropriately manage the time to be measured.

In general, an error in time measured by a measurement device such as an RTC increases with the passage of time, and may cause a communication error at a certain point in time. When there is a possibility of time drift and there is a possibility that a communication error that has occurred is caused by time drift, the information processing apparatus 100 can appropriately manage the time to be measured, by executing a predetermined operation for correcting the time drift. Accordingly, the information processing apparatus 100 can reduce the occurrence of a communication error caused by time drift.

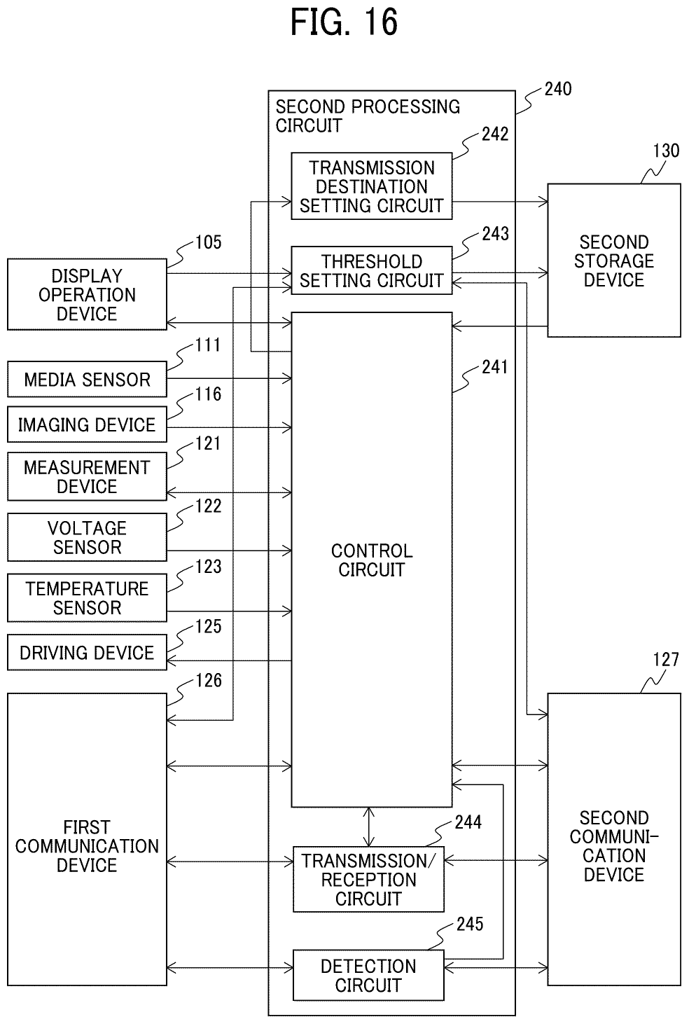

FIG. 16 is a block diagram schematically illustrating a configuration of a second processing circuit in an information processing apparatus according to another embodiment.

A second processing circuit 240 is used instead of the second processing circuit 140 of the information processing apparatus 100, and executes the monitoring process, the media reading process, and the like, instead of the second processing circuit 140. The second processing circuit 240 includes, for example, a control circuit 241, a transmission destination setting circuit 242, a threshold setting circuit 243, a transmission/reception circuit 244, and a detection circuit 245. The control circuit 241, the transmission destination setting circuit 242, the threshold setting circuit 243, the transmission/reception circuit 244, and the detection circuit 245 may be, for example, independent integrated circuits, microprocessors, or firmware.

The control circuit 241 is an example of circuitry and functions in the same or substantially the same manner as the control unit 141. The control circuit 241 receives an operation signal from the display operation device 105, the first communication device 126, or the second communication device 127, receives a media signal from the media sensor 111, and reads a transmission destination of an input image from the second storage device 130. The control circuit 241 outputs the received media signal to the transmission destination setting circuit 242. The control circuit 241 controls the driving device 125 based on the operation signal and the media signal. The control circuit 241 acquires the current time from the measurement device 121, acquires the input image from the imaging device 116, and transmits the acquired current time and input image to the transmission destination through the first communication device 126 or the second communication device 127. Further, the control circuit 241 receives a time signal from the measurement device 121. The control circuit 241 further receives a voltage signal from the voltage sensor 122, or receives a temperature signal from the temperature sensor 123. The control circuit 241 determines, based on the received signal, whether the time measured by the measurement device 121 is accurate, and sets the current time in the measurement device 121 based on the determination result. Further, the control circuit 241 reads a drift threshold from the second storage device 130. The control circuit 241 receives a detection result of a communication error from the detection circuit 245, and executes the predetermined operation based on the received detection result, the temperature signal, the drift threshold, and the like.

The transmission destination setting circuit 242 is an example of a transmission destination setting unit and functions in the same or substantially the same manner as the transmission destination setting unit 142. The transmission destination setting circuit 242 receives a media signal from the control circuit 241, and sets the transmission destination of the input image in the second storage device 130.

The threshold setting circuit 243 is an example of a threshold setting unit and functions in the same or substantially the same manner as the threshold setting unit 143. The threshold setting circuit 243 receives a setting signal from the display operation device 105, the first communication device 126, or the second communication device 127, and sets the drift threshold in the second storage device 130.

The transmission/reception circuit 244 is an example of a transmission/reception unit and functions in the same or substantially the same manner as the transmission/reception unit 144. The transmission/reception circuit 244 receives the input image and the current time from the control circuit 241, and transmits the input image and the current time to the transmission destination of the input image through the first communication device 126 or the second communication device 127.

The detection circuit 245 is an example of circuitry and functions in the same or substantially the same manner as the detection unit 145. The detection circuit 245 receives a packet from the first communication device 126 or the second communication device 127, detects a communication error, and outputs a detection result to the control circuit 241.

As described above in detail, even when the second processing circuit 240 is used, the information processing apparatus can appropriately manage the time to be measured.

Embodiments of the present disclosure are not limited to the embodiments described above. In an embodiment, for example, the information processing apparatus may include a media conveying path that is a so-called U-turn path to sequentially feed and convey the media placed on the media tray one by one, starting from the top, and eject the media to the ejection tray. In this configuration, the separation roller is located below the feed roller and faces the feed roller.

In another embodiment, the information processing apparatus may include an image forming device instead of or in addition to the imaging device 116. The image forming device is, for example, an inkjet or laser printer, and is located at a position corresponding to the position of the imaging device 116 to form an image (print predetermined information) on a medium conveyed.

The information processing apparatus may execute the processing of steps S706 to S708 in FIG. 12 at the time of activation of the information processing apparatus and/or periodically, and may notify the user of the occurrence of a time drift when the estimated value of the time drift is greater than or equal to the drift threshold.

When a communication error is detected by the detection unit 145, the control unit 141 may also execute the predetermined operation in a case where the first condition is satisfied and the second condition is not satisfied or in a case where the second condition is satisfied and the first condition is not satisfied.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising:
a measurement circuit to measure time; and
a control circuit to determine whether the measured time is accurate and execute a predetermined operation of correcting a time drift based on a determination that the measured time is inaccurate.

2. The information processing apparatus according to claim 1, wherein
the control circuit determines whether the measured time is accurate, based on whether a first condition in which there is a possibility that the measured time drifts is satisfied.

3. The information processing apparatus according to claim 2, wherein
the control circuit determines whether the first condition is satisfied, based on at least one of a voltage supplied to the measurement circuit, an ambient temperature of the measurement circuit, or a specification of the measurement circuit.

4. The information processing apparatus according to claim 2, wherein
the control circuit determines whether the first condition is satisfied, based on a history of voltages supplied to the measurement circuit or ambient temperatures of the measurement circuit, from a previous time when a time is set in the measurement circuit to a current time.

5. The information processing apparatus according to claim 2, wherein
the control circuit determines whether the first condition is satisfied, based on an elapsed time from a previous time when a time is set in the measurement circuit.

6. The information processing apparatus according to claim 2, wherein
the control circuit calculates an estimated value of drift in the measured time, compares the estimated value with a threshold to determine whether the first condition is satisfied, and sets the threshold.

7. The information processing apparatus according to claim 2, wherein
the control circuit determines that the first condition is satisfied,
when time setting has not been executed after activation of the information processing apparatus,
when synchronization with a server that distributes time information is not successful after the activation of the information processing apparatus, or
when a predetermined amount of time or more has elapsed since the time setting was executed or since the synchronization with the server was successful.

8. The information processing apparatus according to claim 1, further comprising a communication circuit to communicate with an external device, wherein
the predetermined operation includes:
acquiring time information through the communication circuit and setting the acquired time information in the measurement circuit when the information processing apparatus is communicable through the communication circuit; and
notifying a user of a warning when the information processing apparatus is not communicable through the communication circuit.

9. The information processing apparatus according to claim 8, further comprising a transmission destination setting circuit to set a transmission destination to which information is to be transmitted through the communication circuit, wherein
based on a determination that the transmission destination is an external storage device and the measured time is inaccurate,
the control circuit acquires the time information through the communication circuit when the information processing apparatus is communicable through the communication circuit, and
notifies the user of the warning when the information processing apparatus is not communicable through the communication circuit.

10. The information processing apparatus according to claim 8, further comprising a transmission destination setting circuit to set a transmission destination to which information is to be transmitted through the communication circuit, wherein
based on a determination that the transmission destination is an external device connectable for communication without a network and the measured time is inaccurate,
the control circuit inhibits acquisition of the time information from the external device, or inhibits time information acquired from the external device from being set in the measurement circuit.

11. The information processing apparatus according to claim 1, further comprising:
an input terminal to receive an input of power supplied from an external power source;
a switching device to switch between supplying and not supplying the power input to the input terminal to the control circuit; and
a supply device located between the input terminal and the switching device to supply the power input to the input terminal to the measurement circuit, wherein
the information processing apparatus operates using only the power input to the input terminal.

12. The information processing apparatus according to claim 2, further comprising:
a communication circuit to communicate with an external device; and
a detection circuit to detect a communication error with the external device, wherein
in response to a communication error being detected by the detection circuit, the control circuit determines whether a second condition in which there is a possibility that the communication error is caused by time drift is satisfied, and executes the predetermined operation based on a determination that the measured time is inaccurate and the second condition is satisfied.

13. The information processing apparatus according to claim 12, wherein
in response to a communication error being detected by the detection circuit, the control circuit inhibits execution of the predetermined operation based on a determination that the measured time is accurate or based on a determination that the second condition is not satisfied.

14. The information processing apparatus according to claim 12, wherein
the control circuit determines that the second condition is satisfied,
when a communication interface in which the communication error has occurred is a first communication interface,
when the communication interface in which the communication error has occurred is not a second communication interface,
when the communication error has occurred during authentication using a specific user management method, or
when the communication error has occurred during file sharing using specific hardware or software.

15. The information processing apparatus according to claim 12, wherein the predetermined operation includes one of:
issuing a notification indicating that there is a possibility that the communication error is caused by factors including time drift; and
issuing a notification prompting time setting.

16. The information processing apparatus according to claim 12, wherein
when a server that distributes time information has not been set or when a communication connection to an external network is enabled,
the control circuit issues a notification prompting setting of the server to execute the predetermined operation.

17. The information processing apparatus according to claim 12, wherein
the information processing apparatus includes an image scanner, and
the control circuit acquires time information from a device to which an image generated by the information processing apparatus is to be transmitted or from another image reading apparatus to execute the predetermined operation.

18. An information processing method comprising:
measuring time;
determining whether the measured time is accurate; and
executing a predetermined operation of correcting a time drift based on a determination that the measured time is inaccurate.

19. A computer-readable, non-transitory medium storing a computer program, which causes an information processing apparatus to execute a process, the process comprising:
measuring time;
determining whether the measured time is accurate; and
executing a predetermined operation of correcting a time drift based on a determination that the measured time is inaccurate.
